(19) United States
(12) Patent Application Publication
(10) Pub. No.: US 2026/0215996 A1
(43) Pub. Date: Jul. 30, 2026

(54) COMPRESSION ANALYSIS VIA AIRWAY PARAMETERS

(71) Applicant: Stryker Corporation, Portage, MI (US)

(72) Inventors: Darren Schaaf, Portage, MI (US); Adithya Chandrashekharan, Portage, MI (US); Scott Batzer, Vicksburg, MI (US); Aaron Furman, Kalamazoo, MI (US); Kerry Castor, Kalamazoo, MI (US); Ed Crampton, Kalamazoo, MI (US)

(73) Assignee: Stryker Corporation, Portage, MI (US)

(21) Appl. No.: 19/141,918

(22) PCT Filed: Dec. 19, 2023
(86) PCT No.: PCT/US2023/084934

§ 371 Date: Jun. 20, 2025

Related U.S. Application Data
(60) Provisional application No. 63/434,284, filed on Dec. 21, 2022.

(51) Int. Cl. A61H 31/00

(52) U.S. Cl. CPC A61H 31/005; A61H 31/006; A61H 2201/107; A61H 2201/5007; A61H 2230/405

(57) ABSTRACT

Detecting and analyzing chest compressions via airway parameters, and performing one or more actions based on the compression analysis is described. In some examples, a sensor detects a carbon dioxide (CO₂) parameter associated with a subject, and a processor generate CO₂ data indicating the CO₂ parameter. The processor further identifies a chest compression artifact exhibited in the CO₂ data, determines, based on the chest compression artifact, a chest compression parameter associated with chest compressions that are being administered to the subject, and causes performance of an action based on an analysis of the chest compression parameter.

### CROSS REFERENCE TO RELATED APPLICATIONS

This application is the 35 U.S.C. § 371 National Phase of International App. No. PCT/US2023/084934, filed on Dec. 19, 2023, titled “COMPRESSION ANALYSIS VIA AIRWAY PARAMETERS”, which claims the benefit of U.S. Provisional Application No. 63/434,284, titled “COMPRESSION ANALYSIS VIA AIRWAY PARAMETERS” and filed on Dec. 21, 2022, and each of which is incorporated by reference herein in its entirety.

### BACKGROUND

Cardiopulmonary resuscitation (CPR) is a procedure that involves administering chest compressions to a subject in combination with ventilations. CPR can be performed manually by a rescuer (e.g., using their hands to administer chest compressions and optionally exhaling air from their lungs into the subject's mouth or nose). Additionally, or alternatively, CPR can be performed using devices, such as a ventilation device and/or a mechanical chest compression device. In some cases, a monitor-defibrillator may also be used to monitor and treat the subject, such as by administering defibrillation therapy to the subject via defibrillation electrodes.

### BRIEF DESCRIPTION OF THE DRAWINGS

FIG. 1 illustrates an example rescue scene where chest compressions can be analyzed via airway parameters, according to the techniques described herein.

FIG. 2 illustrates example chest compression artifacts exhibited in capnograms, according to the techniques described herein.

FIG. 3 illustrates an example process for performing an action based on an analysis of one or more chest compression parameters determined from a chest compression artifact exhibited in carbon dioxide (CO₂) data, according to the techniques described herein.

FIG. 4 illustrates an example process for performing an action based on a concordance or a discordance between CO₂ data and another type(s) of airway data associated with a subject, according to the techniques described herein.

FIG. 5 illustrates an example process for ventilation coaching based on compression analysis via airway parameters, according to the techniques described herein.

FIG. 6 illustrates an example process for coaching or controlling CPR based on compression analysis via airway parameters, according to the techniques described herein.

FIG. 7 illustrates an example of a monitor-defibrillator configured to perform various functions described herein.

FIG. 8 illustrates a chest compression device configured to perform various functions described herein.

### SUMMARY

According to an aspect is provided a system comprising a processor configured receive or otherwise determine values of a CO₂ parameter detected by a sensor. The sensor may be configured to detect a carbon dioxide (CO₂) parameter associated with a subject and a processor. The processor is configured to generate CO₂ data indicating the CO₂ parameter. The processor is configured to identify a chest compression artifact exhibited in the CO2 data. The processor is configured to determine, based on the chest compression artifact, a chest compression parameter associated with chest compressions that are being administered to the subject. The processor is configured to cause performance of an action based on an analysis of the chest compression parameter.

Optionally, the processor is further configured to receive or otherwise determine an airflow parameter associated with air flowing in a fluidic circuit comprising an airway of the subject. The sensor may be further configured to detect the airflow parameter associated with air flowing in the fluidic circuit comprising the airway of the subject. The processor is further configured to: generate airflow data indicating the airflow parameter; identify a second chest compression artifact exhibited in the airflow data; and determine that chest compressions are being administered to the subject based on the chest compression artifact and the second chest compression artifact.

Optionally, the processor is further configured to receive or otherwise determine an air pressure parameter associated with an airway of the subject. The sensor may be further configured to detect the air pressure parameter associated with the airway of the subject. The processor is further configured to: generate air pressure data indicating the air pressure parameter; identify a second chest compression artifact exhibited in the air pressure data; and determine that chest compressions are being administered to the subject based on the chest compression artifact and the second chest compression artifact.

Optionally, the system further comprises an output device.

Optionally, the chest compression parameter comprises a number of the chest compressions that have been consecutively administered to the subject. Optionally, the analysis of the chest compression parameter comprises determining that the number of the chest compressions satisfies a threshold. Optionally, causing the performance of the action comprises causing coaching information to be output via the output device, the coaching information comprising a timing of administering a ventilation to the subject via a ventilation device.

Optionally, the analysis of the chest compression parameter comprises: determining, by the processor, that the number of the chest compressions satisfies a first threshold; and in response to the determining that the number of the chest compressions satisfies the first threshold, determining, by the processor, that a value of the CO2 parameter received by the processor fails to satisfy a second threshold. Optionally, the causing the action to be performed comprises causing coaching information to be output via the output device, the coaching information based on the determining that the value fails to satisfy the second threshold.

Optionally, the processor is further configured to detect, based on the CO₂ data, a return of spontaneous circulation (ROSC) associated with the subject.

Optionally, the analysis of the chest compression parameter comprises determining that the chest compressions are being administered to the subject after the ROSC.

Optionally, causing the performance of the action comprises causing coaching information to be output via the output device, the coaching information comprising a recommendation to cease administering the chest compressions, e.g. after determining that the chest compressions are being administered to the subject after the ROSC.

Optionally, the system further comprises a mechanical chest compression device configured to administer the chest compressions.

Optionally, causing the performance of the action comprises causing an instruction to cease administering the chest compressions to be sent to the mechanical chest compression device, e.g. after determining that the chest compressions are being administered to the subject after the ROSC.

Optionally, the processor is further configured to: determine that a value of the CO₂ parameter detected by the sensor fails to satisfy a threshold, wherein causing the performance of the action comprises causing an instruction to adjust a depth of the chest compressions to be sent to the mechanical chest compression device.

Optionally, the sensor is an airway sensor. Optionally the airway sensor is a component of, or an accessory to, a ventilation device that is being used to ventilate the subject as part of cardiopulmonary resuscitation (CPR) that is being administered to the subject.

According to an aspect is provided a method comprising: receiving, by a processor, a carbon dioxide (CO₂) parameter associated with a subject; generating, by the processor, CO₂ data indicating the CO parameter; identifying, by the processor, a chest compression artifact exhibited in the CO₂ data; determining, by the processor, and based on the chest compression artifact, a chest compression parameter associated with chest compressions that are being administered to the subject; and causing, by the processor, an action to be performed based on an analysis of the chest compression parameter. The CO₂ parameter received by the processor may have been detected by a sensor.

Optionally, the method further comprises: receiving, by the processor, an airflow parameter associated with air flowing in a fluidic circuit comprising an airway of the subject; generating, by the processor, airflow data indicating the airflow parameter; identifying, by the processor, a second chest compression artifact exhibited in the airflow data; and determining, by the processor, that the chest compressions are being administered to the subject based on the chest compression artifact and the second chest compression artifact. The airflow parameter received by the processor may have been detected by a sensor.

Optionally, the method of further comprises: receiving, by the processor an air pressure parameter associated with an airway of the subject; generating, by the processor, air pressure data indicating the air pressure parameter; identifying, by the processor, a second chest compression artifact exhibited in the air pressure data; and determining, by the processor, that the chest compressions are being administered to the subject based on the chest compression artifact and the second chest compression artifact. The air pressure parameter received by the processor may have been detected by a sensor.

Optionally, the chest compression parameter comprises a number of the chest compressions that have been consecutively administered to the subject; the analysis of the chest compression parameter comprises determining, by the processor, that the number of the chest compressions satisfies a threshold; and the causing the action to be performed comprises causing coaching information to be output via an output device, the coaching information comprising a timing of administering a ventilation to the subject via a ventilation device.

Optionally, the chest compression parameter comprises a number of the chest compressions that have been consecutively administered to the subject; the analysis of the chest compression parameter comprises: determining, by the processor, that the number of the chest compressions satisfies a first threshold; and in response to the determining that the number of the chest compressions satisfies the first threshold, determining, by the processor, that a value of the CO₂ parameter received by the processor fails to satisfy a second threshold; and the causing the action to be performed comprises causing coaching information to be output via an output device, the coaching information based on the determining that the value fails to satisfy the second threshold.

Optionally, the method further comprises detecting, by the processor, and based on the CO₂ data, a return of spontaneous circulation (ROSC) associated with the subject.

Optionally, the analysis of the chest compression parameter comprises determining, by the processor, that the chest compressions are being administered to the subject after the ROSC.

Optionally, the causing the action to be performed comprises causing coaching information to be output via an output device, the coaching information comprising a recommendation to cease administering the chest compressions, e.g. after determining that the chest compressions are being administered to the subject after the ROSC.

Optionally, the causing the action to be performed comprises causing an instruction to cease administering the chest compressions to be sent to a mechanical chest compression device that is administering the chest compressions, e.g. after determining that the chest compressions are being administered to the subject after the ROSC.

It will be appreciated that any of the aspects, features and options described in view of any of the system apply equally to the method, and vice versa. It will also be clear that any one or more of the above aspects, features and options can be combined.

### DETAILED DESCRIPTION

This disclosure provides techniques, devices, and systems for detecting and analyzing chest compressions via airway parameters, and for performing one or more actions based on the compression analysis. In an example, a rescuer, or a team of rescuers, may be providing care to a subject (e.g., a patient) at a rescue scene. For example, the subject may be unresponsive and not breathing (or breathing abnormally), which may be due to the subject experiencing a sudden cardiac arrest or another life-threatening event. During the rescue effort, the rescuer(s) may perform procedures and/or utilize devices to provide medical care to the subject. For example, the rescuer(s) may establish or ensure safe and effective passage of air into and out of the subject's lungs while attempting to resuscitate the subject. In an example, the rescuer(s) may utilize a ventilation device, such as a bag-valve-mask (BVM) device, to administer positive pressure ventilation (PPV) to the subject as part of CPR. In addition, a sensor(s) may be used during the rescue effort to detect one or more airway parameters associated with the subject. The airway parameter(s) may include, without limitation, a CO₂ parameter(s), such as a partial pressure of CO₂ in the airway of the subject. Airway data indicating the detected airway parameter(s) may be generated by a processor(s). For example, CO₂ data, such as a CO₂ waveform (or capnogram), indicating the CO₂ parameter(s) may be generated by the processor(s). Capnography is the monitoring of the concentration or partial pressure of CO₂ in the respiratory gases of the subject.

The rescue effort may further involve the administration of chest compressions to the subject as part of CPR. Chest compressions may be administered manually and/or using a mechanical chest compression device that is disposed on the subject. Because these chest compressions are administered while the airway data is being generated, the chest compressions may cause noise and/or artifacts to be exhibited in the airway data, such as the CO₂ waveform noted above. Chest compressions compress the entire chest cavity, including the lungs, and, as a consequence, artifacts (e.g., relatively high frequency, low amplitude signals, as compared to the lower-frequency, higher-amplitude signals that correspond to the breaths of the subject) can be exhibited in the airway data (e.g., the CO₂ waveform).

Techniques, devices, and systems are described herein for detecting and/or analyzing chest compressions via airway parameters. For example, as described above, a sensor(s) may detect a CO₂ parameter associated with a subject, such as a subject who is undergoing CPR. A processor(s) may generate CO₂ data indicating the CO₂ parameter, and may identify a chest compression artifact(s) exhibited in the CO₂ data. Based on the identified chest compression artifact(s), the processor(s) may determine a chest compression parameter(s) associated with chest compressions that are being administered to the subject. The chest compression parameter(s) may include any suitable parameter, such as a frequency or rate of the chest compressions, a rhythm of the chest compressions, a pattern of the chest compressions, a position of the chest compressions (e.g., relative to the body of the subject 104), a timing of the chest compressions (e.g., a timestamp, a relative timing of the compressions relative to another event(s), etc.), a depth of the chest compressions, a force of the chest compressions, a number of consecutively-administered chest compressions (e.g., a count, a running total, etc.), or the like. The chest compression parameter(s) may be analyzed by the processor(s), and the processor(s) may cause performance of an action(s) based on the analysis of the chest compression parameter(s).

In an illustrative example, the compression analysis described herein may be used to coach the rescuer(s) regarding the provisioning of ventilations and/or CPR generally. For example, the techniques, devices, and systems described herein may be used to automate the counting of chest compressions during CPR in order to coach the rescuer(s) as to when (e.g., a time at which) a ventilation (or PPV) should be administered to the subject. That is, the chest compression parameter(s) determined from the chest compression artifact may include a count (or a number) of the chest compression administered to the subject since a last ventilation was administered to the subject, and if the chest compression count satisfies (e.g., is equal to or greater than, or is strictly greater than) a threshold (e.g., a threshold of 30 compressions), the processor(s) may cause coaching information to be output via an output device (e.g., a display). Such coaching information may indicate a timing of administering a ventilation to the subject via the ventilation device. This is merely an exemplary action that can be performed based on the compression analysis, and other actions based on compression analysis are contemplated. For example, if a mechanical chest compression device is administering the chest compressions, an instruction may be sent to the chest compression device to start or stop chest compressions, and/or to adjust a parameter(s) of the chest compressions. In some examples, the airway parameter(s) may be analyzed, and an action(s) may be performed based on the analysis of the ventilation parameter. For instance, if a value of the CO₂ parameter associated with the subject fails to satisfy a threshold, perhaps indicating that the subject is not getting enough circulation, CPR coaching information may be output to coach the rescuer(s) to adjust the depth of the chest compressions, and/or an instruction may be sent to the chest compression device to do make a similar adjustment.

In some examples, the CO₂ data may be augmented with other airway data relating to other types of airway parameters to enhance the analysis noted above. For example, a sensor(s) may be used during the rescue effort to detect one or more airflow parameters associated with air flowing in a fluidic circuit including the airway of the subject and/or to detect one or more air pressure parameters associated with the airway of the subject. In some examples, such airflow and/or air pressure parameters may be used to corroborate the detection of chest compressions via the CO₂ parameter(s). For instance, chest compression artifacts may also be exhibited in airflow data and/or air pressure data. For example, administration of a chest compression to the subject may cause a fluctuation in the flow rate of air and/or a fluctuation in the pressure associated with the airway of the subject. As such, the CO₂ data (e.g., the CO₂ waveform) may be used as a primary signal for detecting chest compressions and/or determining chest compression parameter(s) associated therewith, and airflow and/or air pressure data may be used as a secondary signal to confirm and/or validate the detection of chest compressions and/or the chest compression parameters determined via the primary signal. In other words, the availability of augmentative data, such as airflow data and/or air pressure data, may increase the confidence of a determination relating to chest compressions that is made based on the CO₂ data. In some examples, a discordance between the CO₂ data (e.g., the CO₂ waveform) and another type(s) of airway data (e.g., airflow and/or air pressure data) may be indicative of a potential issue relating to the care that is being provided to the subject, such as an air leak associated with the ventilation device and/or an inadequate seal of a mask around the subject's nose and mouth. An example of such discordance is a scenario where airflow data indicates that air is flowing at an expected flow rate(s) via the subject's airway, but the CO₂ data indicates a lower-than-expected partial pressure of CO₂. Accordingly, appropriate action(s) can be taken to address a potential issue, such as an action of outputting information via an output device to notify the rescuer(s). As used herein, in the context of comparing first data with second data, the term “discordance,” and its equivalents, may refer a condition where the first data fails to meet a first predefined criterion (or first predefined criteria) at a time at which the second data meets a second predefined criterion (or second predefined criteria), or vice versa. As an example, there may be a discordance between airflow data and CO₂ data if an airflow parameter value in the airflow data satisfies a first threshold (thereby meeting a first predefined criterion) at a time at which a CO₂ parameter value fails to satisfy a second threshold (thereby failing to meet a second predefined criterion). Such a discordance may indicate a lack of agreement or a lack of consistency between the airflow data and CO₂ data (e.g., that air is flowing as expected while CO₂ is lower-than-expected). The term “discordance,” and its equivalents, may also refer a condition where a correlation metric correlating the first data and the second data meets a predefined criterion (or predefined criteria). As an example, there may be a discordance between airflow data and CO₂ data if a time interval between a first peak (e.g., a maximum airflow parameter value) in the airflow data and a second peak (e.g., a maximum CO₂ parameter value) in the CO₂ data satisfies (e.g., is equal to or greater than, or is strictly greater than) a threshold. In this example, the time interval is an example of a correlation metric that meets a predefined criterion by satisfying the threshold.

The techniques, devices, and systems for detecting and analyzing chest compressions via airway parameters, and for performing one or more actions based on the compression analysis can improve the medical care that is provided to a subject, which, in turn, improves patient outcomes. For instance, coaching information (e.g., ventilation coaching and/or CPR coaching) based on the analysis of a chest compression parameter(s) determined via airway parameters can result in ventilations (or PPVs) and/or chest compressions (i.e., CPR) being performed correctly by rescuers more often. Additionally, or alternatively, devices, such as mechanical chest compression devices, can receive compression feedback from the airway-based compression analysis described herein to improve the performance of the devices and/or mitigate instances of treatment (e.g., chest compressions, ventilations, defibrillation shocks, etc.) being provided by automated devices in a suboptimal manner.

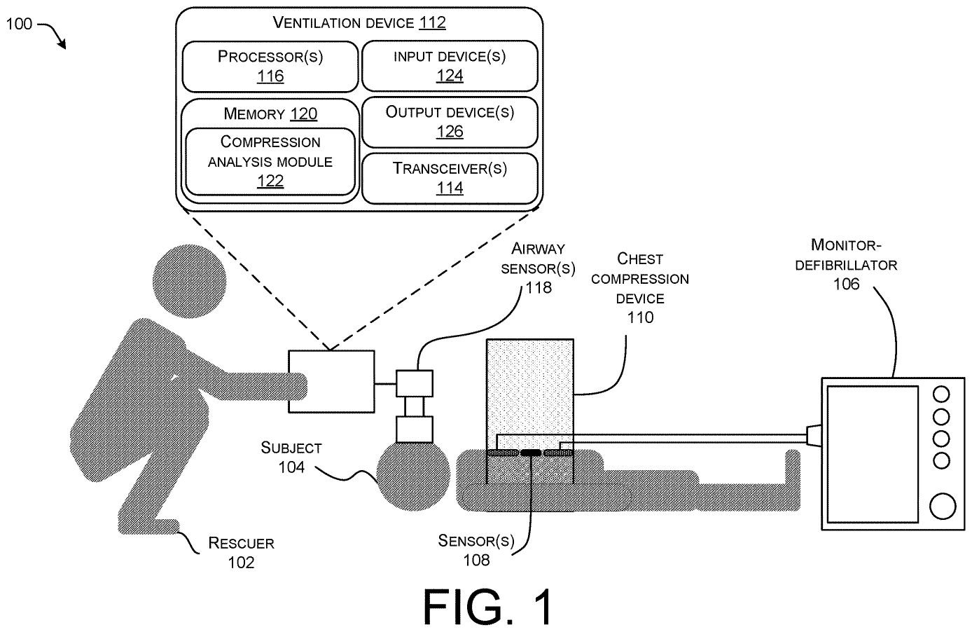

FIG. 1 illustrates an example rescue scene 100 where chest compressions can be analyzed via airway parameters, according to the techniques described herein. The rescue scene 100, in some implementations, is within a clinical environment, such as a hospital or other managed care facility. In some cases, the rescue scene 100 is outside of a clinical environment, such as outdoors, in a home, in a workplace, in a patient transport environment (e.g., an ambulance, helicopter, etc.), or the like. In some cases, the rescue scene 100 is a pre-hospital environment, such that the subject 104 is actively being transported or transferred to a hospital environment. In various implementations, a rescuer 102 is treating a subject 104 (e.g., a patient) at the rescue scene 100. For instance, the rescuer 102 is an emergency medical technician (EMT) professional monitoring and/or treating a medical condition of the subject 104. In some cases, the subject 104 is experiencing cardiac arrest or some other dangerous medical condition.

In some examples, the rescuer 102 may utilize a monitor-defibrillator 106 (sometimes referred to herein as an “external defibrillator 106”) to monitor the condition of the subject 104 and/or to treat the subject 104 by administering defibrillation therapy thereto. In some examples, a different type of monitoring device can be utilized in place of the monitor-defibrillator 106 shown in FIG. 1, such as a medical imaging device, an ultrasound monitor, a standalone electrocardiogram (ECG) monitor, or another type of patient monitor. The monitor-defibrillator 106 includes and/or is communicatively coupled to a sensor(s) 108. The sensor(s) 108 is configured to detect at least one physiological parameter of the subject 104. Examples of physiological parameters include, for instance, an ECG, an impedance, a force administered to the subject 104, a blood pressure, a blood oxygenation (e.g., a pulse oximetry value, a regional oximetry value, etc.), an electroencephalogram (EEG), a temperature, a heart sound, a blood flow rate, a physiological geometry (e.g., a shape of a blood vessel, an inner ear shape, etc.), a heart rate, a pulse rate, an airway parameter(s), or the like. As used herein, the term “airway parameter,” and its equivalents, may refer to a metric related to and/or indicative of air present in and/or flowing through the lungs, trachea, throat, or mouth of the subject 104. Examples of airway parameters include parameters indicative of a characteristic of the airway of the subject 104, or a characteristic of the respirations of the subject 104, or a characteristic of ventilations being provided to the subject 104, such as CO₂ parameters (e.g., a partial pressure of CO₂, a capnograph, an end tidal CO₂ (EtCO₂) parameter, a level of CO₂ in the air present in the airway of the subject 104 and/or flowing in a fluidic circuit including the airway of the subject 104, etc.), an end tidal gas parameter (e.g., end tidal oxygen), a partial pressure of oxygen, a level of oxygen in the air present in the airway of the subject 104 and/or flowing in a fluidic circuit including the airway of the subject 104, a partial pressure of argon, a level of argon in the air present in the airway of the subject 104 and/or flowing in a fluidic circuit including the airway of the subject 104, a partial pressure of nitrogen, a level of nitrogen in the air present in the airway of the subject 104 and/or flowing in a fluidic circuit including the airway of the subject 104, a temperature of the air present in the airway of the subject 104 and/or flowing in a fluidic circuit including the airway of the subject 104, a humidity of the air present in the airway of the subject 104 and/or flowing in a fluidic circuit including the airway of the subject 104, ventilation rate, inspiratory and/or expiratory time, airflow parameters (e.g., a flow rate of air flowing in a fluidic circuit including the airway of the subject 104, a volume of air flowing in a fluidic circuit including the airway (e.g., inspiratory volume, expiratory volume, tidal volume, or minute volume), or the like), or air pressure parameters indicative of a pressure associated with the airway of the subject 104 (e.g., positive end-expiratory pressure (PEEP), plateau pressure, peak inspiratory pressure (PIP), etc.). In some examples, the sensor 108 includes at least one of electrodes, a detection circuit, defibrillator pads, a force sensor, a blood pressure cuff, an ultrasound-based blood pressure sensor, an ultrasound-based blood pressure sensor, an invasive (e.g., intra-arterial) blood pressure sensor (e.g., including a cannula inserted into the subject 104), a gas sensor (e.g., a CO₂ and/or oxygen sensor), a capnography sensor, a flowmeter, a pressure sensor, a pulse oximetry sensor a regional oximetry sensor, a thermometer, a microphone, an ultrasound transducer, a medical imaging device (e.g., an ultrasound imaging device), or the like. In various cases, the monitor-defibrillator 106 outputs the physiological parameter(s) to the rescuer 102. For instance, the monitor-defibrillator 106 includes a display, a speaker, or haptic feedback device that conveys the physiological parameter(s) to the rescuer 102. In some examples, the monitor-defibrillator 106 is an automated external defibrillator (AED).

In some examples, a mechanical chest compression device 110 is disposed on the subject 104 and is configured to administer chest compressions to the subject 104. For example, the chest compression device 110 may include a compressor that is operatively coupled to a motor, and the compressor is configured to physically administer a force to the chest of the subject 104 that compresses the chest of the subject 104. In some cases, the chest compression device 110 is configured to detect one or more physiological parameters of the subject 104, such as via the sensor(s) 108 and/or a different sensor(s).

The rescuer 102 is shown in FIG. 1 as using a ventilation device 112 to provide assisted ventilation to the subject 104 at the rescue scene 100. It is to be appreciated that the monitor-defibrillator 106, the chest compression device 110, and/or the ventilation device 112 may be portable devices capable of monitoring and/or treating the subject 104 outside of a clinical environment. In some cases, the monitoring and/or treatment of the subject 104 is optimized by communication between the monitor-defibrillator 106, the chest compression device 110, and/or the ventilation device 110. In other words, two or more of the devices 106, 110, 112 may be communicatively coupled to communicate with (e.g., transmit/receive data or signals to/from) each other.

According to various implementations, the ventilation device 112 includes a gas source, an element configured to move the gas in and out of the airway of the subject 104, as well as an interface configured to connect the ventilation device 112 to the airway of the subject 104. For instance, the gas source may include an oxygen tank or other container for an oxygen-containing gas that is administered to the subject 104. The element configured to move the gas in and out of the airway of the subject 104, in some cases, includes a manual device such as a bag-valve mask (BVM) device (e.g., a bag that is manually squeezed by the rescuer 102 in order to propel the gas into the airway of the subject 104 and that is manually released by the rescuer 102 in order to allow exhalation from the subject 104) or an automated device such as a mechanical ventilator. In some implementations, the interface includes a mask that is disposed on the face of the subject 104 (e.g., over the mouth and nose of the subject 104), an endotracheal tube disposed in the trachea of the subject 104, or a supraglottic device disposed in a pharynx of the subject 104. The ventilation device 112, in various cases, includes at least one duct (e.g., a tube, pipe, or the like) that is fluidly connected to the airway of the subject 104, and through which air is moved into, through, and out of the airway of the subject 104. In some cases, the ventilation device 112 includes a BVM device that includes a number of valves, including a valve configured to prevent exhaled air from flowing back into the bag, thus avoiding rebreathing of expired CO₂. A supraglottic device, in various examples, includes a bag attached to a duct that fits over or otherwise directs air to the glottic opening of the subject 104, without being inserted through the vocal cords. In various examples, the ventilation device 112 includes a valve that selectively vents a fluid circuit connecting an interior of the ventilation device 112 and the airway of the subject 104 to an external environment.

In some instances, the ventilation device 112 is communicatively coupled to the monitor-defibrillator 106 and/or the chest compression device 110 via one or more wired interfaces, one or more wireless interfaces (e.g., a transceiver 114), or a combination thereof. In an example, the ventilation device 112 may include a processor(s) 116 configured to cause assisted ventilation to be administered to the subject 104, and the monitor-defibrillator 106 may transmit a signal to the ventilation device 112 that causes the processor(s) 116 to adjust a parameter of the assisted ventilation (e.g., a ventilation rate, a length of a ventilation pause, a volume of air administered to the subject 104, a flow rate of air administered to the subject 104, or any combination thereof) and/or activates the valve in order to vent the ventilation device 112.

In various cases, the airway parameter(s) noted above are detected by one or more airway sensors 118. In some instances, the airway sensor(s) 118 are included in, or integrated with, the ventilation device 112. For example, the airway sensor(s) 118 are integrated with and/or attached to a mechanical ventilator, a BVM, an endotracheal tube, a duct of the ventilation device 112, airway adaptors, or any other device fluidly connected to the airway of the subject 104. In some examples, the airway sensor(s) 118 are communicatively coupled to a processor(s) of the monitor 106 and/or a processor(s) 116 of the ventilation device 112. For example, the airway sensor(s) 118 are connected via one or more wired interfaces, one or more wireless interfaces, or a combination thereof.

The airway sensor(s) 118 include one or more types of sensors configured to detect the airway parameter(s). In various cases, the airway sensor(s) 118 include an electrical circuit configured to generate an analog signal (e.g., an electrical current or voltage) based on the airway parameter(s) of the subject 104. Optionally, the airway sensor(s) 118 include an analog-to-digital converter (ADC) that converts the analog signal into a digital signal. In particular implementations, the airway sensor(s) 118 include a transmitter and/or transceiver configured to transmit a signal to the monitor-defibrillator 106 and/or the ventilation device 112 based on the digital signal. In some examples, the airway sensor(s) 118 include a pressure-gradient flowmeter, an ultrasound-based flow sensor, a turbine-based flowmeter, a wire anemometer (including, e.g., a heated wire that changes temperature and resistance based on the magnitude of airflow it is exposed to), an analogic differential pressure flow sensor, or a combination thereof.

A pressure-gradient flowmeter, for example, operates by inducing a pressure differential in the duct. In some examples, the pressure-gradient flow meter includes an element that induces the pressure differential on either side of the element. The pressure-gradient flow meter, in various implementations, includes a pressure sensor configured to detect the difference between the sides of the element. For instance, the pressure-gradient flowmeter includes a diaphragm exposed to pressure from one side of a resistor on one of its sides, and exposed to pressure from the other side of the resistor on its other side. The diaphragm includes and/or is integrated with strain gauges, for example. Thus, in various cases, the pressure-gradient flowmeter directly measures the difference in pressures and is configured to measure bi-directional flow through the duct. The flow rate through the sensor is determined based on the different pressures, in accordance with Bernoulli's principle. In some implementations, a high-efficiency particulate absorbing filter (HEPA) filter induces the pressure differential in the pressure-gradient flowmeter. In addition to inducing the pressure differential, the HEPA filter prevents the passage of airborne diseases from the subject 104 through the duct, which can protect the rescuer 102.

In some implementations, the airway sensor(s) 118 includes a bidirectional airflow sensor, which is configured to detect both inspiratory and expiratory airflow through the airway of the subject 104. For instance, the airway sensor(s) 118 includes a two-way thermal mass sensor, such as the sensor described in U.S. Pub. No. 2018/0160970, which is incorporated herein by reference. The two-way thermal mass sensor measures a flow rate of air through a bidirectional duct in both directions. When the duct is fluidly connected to the airway of the subject 104, the flow rate may be indicative of the flow rate of air entering the lungs of the subject 104 on insufflation and the flow rate of air expired from the lungs of the subject 104 on expiration. The two-way thermal mass sensor, for instance, detects a flow rate based on a temperature gradient that is correlated to the amount of air flowing through the duct. Unlike some pressure-gradient flowmeters, the two-way thermal mass sensor provides negligible resistance to air flow.

In various examples, the two-way thermal mass sensor includes a heater element mounted in the interior of the duct, as well as at least one temperature sensor upstream from the heater element in the interior of the air duct, and at least one temperature sensor downstream from the heater element in the interior of the air duct. Air flow through the air duct causes a transfer of heat from the heater element to the air, which is detectable by at least one of the temperature sensors. For example, the two-way thermal mass sensor has a sensor dead space <10 mL and airway resistance <1.8 cmH²).L.S.s⁻¹ at 60 L. min⁻¹ ).

In various implementations, the airway sensor(s) 118 includes a pressure sensor configured to detect a pressure associated with the airway of the subject 104. For example, the pressure sensor includes an electrical circuit that includes a pressure transducer or pressure-sensitive resistor connected to the airway of the subject 104. The circuit generates an analog signal that is based on the pressure of the airway of the subject 104.

According to some examples, the airway sensor(s) 118 includes a CO₂ sensor, such as a nondispersive Infrared (NDIR) sensor or spectrometer that uses spectroscopy to detect a concentration of CO₂ in the airway of the subject 104. Other types of CO₂ sensors are optionally used, such as a photoacoustic sensor or a heteropolysiloxane-based sensor. In some cases, the airway sensor(s) 118 includes an O₂ sensor, such as zirconia sensor, an ultrasound sensor, a paramagnetic sensor, or a titanium sensor. In some examples, the CO₂ sensor is a mainstream or a sidestream sensor. For example, a mainstream CO₂ sensor is either an on-airway sensor (e.g., an infrared sensor including an infrared source, an optical path, and an infrared detector), and includes a cleanable and/or disposable tube with a window suitable for an accurate infrared-based measurement. In some instances, a sidestream CO₂ sensor includes a sampling tube through which an air sample is syphoned from the airway of the subject 104 to a capnograph sensor.

In various implementations, the monitor-defibrillator 106 and/or ventilation device 112 includes a repository configured to receive air expired from the airway of the subject 104. The repository, for example, is a bag or a box that is fluidically coupled to the airway of the subject 104. The repository is large enough to hold air from several expired breaths of the subject 104, in some cases. The repository mixes the gas it contains. For instance, the repository includes a fan or protrusions that cause turbulent flow within the interior of the repository, in some cases. In some implementations, the airway sensor(s) 118 are configured to detect the airway parameter(s) of the gas held in the repository. For instance, the airway sensor(s) 118 include a CO₂ sensor and/or an O₂ sensor configured to detect a partial pressure of CO₂ and/or O₂ in the air contained in the repository. Because the repository holds multiple breaths over an extended period of time, the airway sensor(s) 118 detecting airway parameter(s) in the repository may be configured to have a relatively long sampling period or low sampling rate. The measured parameters reflect average, or “mixed expired” gas measurements.

FIG. 1 illustrates example components of the ventilation device 112. For example, the ventilation device 112 may include the aforementioned processor(s) 116, such as a central processing unit (CPU), a graphics processing unit (GPU), both CPU and GPU, or another processing unit or component known in the art. The processor(s) 116 is operably connected to memory 120. In various implementations, the memory 120 is volatile (such as random access memory (RAM)), non-volatile (such as read only memory (ROM), flash memory, etc.) or some combination of the two. The memory 120 stores instructions that, when executed by the processor(s) 116, cause the processor(s) 116 to perform various operations described herein. In various examples, the memory 120 stores methods, threads, processes, applications, objects, modules, any other sort of executable instruction, or a combination thereof. An examples depicted in FIG. 1 includes a compression analysis module 122 that, when executed by the processor(s) 116 causes the processor(s) 116 to detect and analyze chest compressions via airway parameters, and to cause performance of one or more actions based on the compression analysis. As used herein, the term “module,” and its equivalents, refers to data including instructions that, when executed by one or more processors, cause the processor(s) to perform one or more operations. In some cases, the memory 120 stores files, databases, or a combination thereof. For example, the ventilation device 112 may collect airway data (e.g., CO₂ data, airflow data, air pressure data, etc.) during use of the ventilation device 112, and this and other data may be stored, at least temporarily, in the memory 120. In some examples, the memory 120 includes RAM, ROM, electrically erasable programmable read-only memory (EEPROM), flash memory, or any other memory technology. In some examples, the memory 120 includes CD-ROMs, digital versatile discs (DVDs), content-addressable memory (CAM), and/or other optical storage, magnetic cassettes, magnetic tape, magnetic disk storage and/or other magnetic storage devices, and/or any other medium (e.g., non-transitory computer-readable medium) which can be used to store the desired information and which can be accessed by the processor(s) 116.

The ventilation device 112 may further include one or more input devices 124 and one or more output devices 126. The input device(s) 124 is configured to receive an input from a user (e.g., the rescuer 102) and includes at least one of a keypad, a cursor control, a touch-sensitive display, a voice input device (e.g., a microphone), a haptic feedback device (e.g., a gyroscope), or any combination thereof. The output device(s) 126 includes at least one of, such as a display(s), a light emitting element(s) (e.g., a light emitting diode(s) (LED(s))), an electrochromic material(s), a speaker(s), a haptic actuator(s), a printer, or the like. As mentioned above, in some examples, the ventilation device 112 may further include a transceiver 114 (e.g., a wireless radio, antenna, or the like) for communicating wirelessly with one or more other devices at the rescue scene 100, such as the monitor-defibrillator 106 and/or the chest compression device 110. The transceiver(s) 114 may include any sort of wireless transceivers capable of engaging in wireless communication (e.g., radio frequency (RF) communication), such as WI-FI®, WIGIG®, WIMAX®, BLUETOOTH®, near-field communication (NFC), radio frequency identification (RFID), or infrared communication. In some examples, one or more of the components depicted as being part of the ventilation device 112 in FIG. 1 may be implemented as components of the monitor-defibrillator 106 and/or the chest compression device 110.

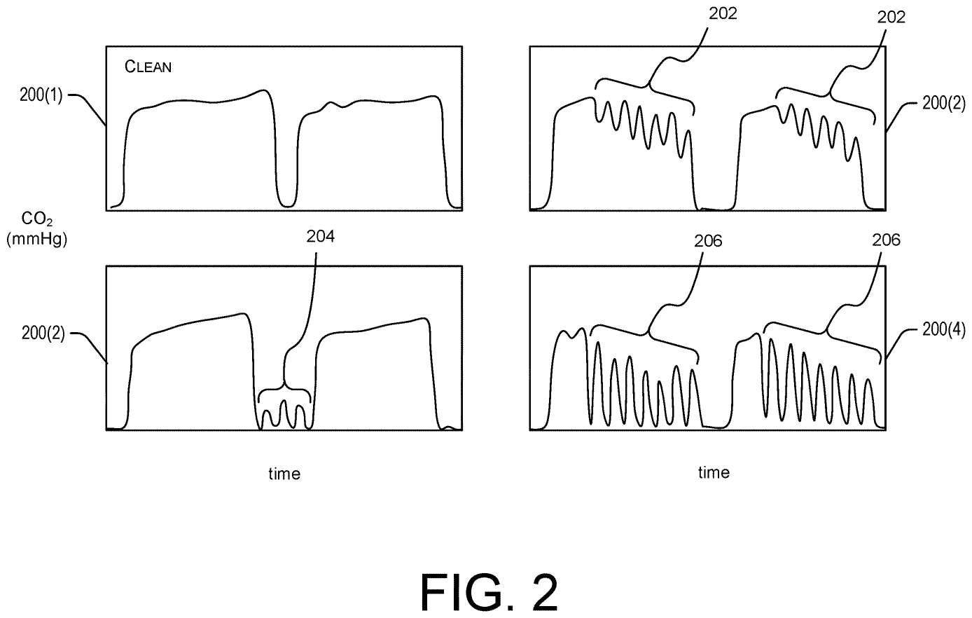

The processor(s) 116 may be configured to generate airway data (e.g., digital data) indicative of one or more of the airway parameters detected by the sensor(s) 118 and/or the sensor(s) 108. For example, the processor(s) 116 may generate CO₂ data indicating a CO₂ parameter associated with the subject 104. As another example, the processor(s) 116 may generate airflow data indicating an airflow parameter associated with air flowing in a fluidic circuit including an airway of the subject 104 and the ventilation device 112 (e.g., air flowing through the subject's airway). As yet another example, the processor(s) 116 may generate air pressure data indicating an air pressure parameter associated with the airway of the subject 104. An example of CO₂ data that may be generated by the processor(s) 116 is depicted in FIG. 2.

FIG. 2 illustrates example chest compression artifacts exhibited in capnograms 200, according to the techniques described herein. FIG. 2 shows four example capnograms 200(1), 200(2), 200(3), and 200(4). The first capnogram 200(1) is an example of a “clean” capnogram with no chest compression artifact exhibited in the CO₂ waveform. The different phases of the respiratory cycle are identifiable in the first capnogram 200(1), such as the inspiratory downstroke, inspiratory baseline, expiratory upstroke, and alveolar plateau. These phases in the CO₂ waveform may correspond to spontaneous breaths and/or PPV breaths (e.g., breaths applied using assisted ventilation administered to the subject 104). Although artifacts exhibited in the CO₂ data (e.g., the CO₂ waveform) can be caused by various sources, the example capnograms 200(2), 200(3), and 200(4) illustrate artifacts 202, 204, 206 caused by chest compressions being administered to the subject 104. A first type of chest compression artifact 202 may be exhibited in the alveolar plateau of the CO₂ waveform. A second type of chest compression artifact 204 may be exhibited in the inspiratory baseline of the CO₂ waveform. A third type of chest compression artifact 206 may span the alveolar plateau and the inspiratory baseline. These chest compression artifacts 202, 204, 206 are exhibited as relatively high frequency, low amplitude signals in the CO₂ waveform, as compared to the lower-frequency, higher-amplitude signals that correspond to the breaths of the subject 104.

Accordingly, the processor(s) 116 may be configured (e.g., by executing the compression analysis module 122) to determine that chest compressions are being administered to the subject 104 by identifying a chest compression artifact(s) 202, 204, 206 exhibited in the CO₂ data (e.g., the CO₂ waveform of a capnogram 200(2), 200(3), 200(4). For example, the processor(s) 116 may analyze the CO₂ waveform to identify a relatively high frequency signal (e.g., by searching the CO₂ waveform for a portion(s) that satisfy a threshold frequency and/or with an amplitude that varies by more than a threshold amount).

Furthermore, the processor(s) 116 may be configured (e.g., by executing the compression analysis module 122) to determine, based on the chest compression artifact 202, 204, 206, one or more chest compression parameters associated with the chest compressions that are being administered to the subject 104. The chest compression parameter(s) may include any suitable parameter, such as a frequency or rate of the chest compressions, a rhythm of the chest compressions, a pattern of the chest compressions, a position of the chest compressions (e.g., relative to the body of the subject 104), a timing of the chest compressions (e.g., a timestamp, a relative timing of the compressions relative to another event(s), etc.), a depth of the chest compressions, a force of the chest compressions, a number of consecutively-administered chest compressions (e.g., a count, a running total, etc.), such as a number of consecutively-administered chest compressions since a last ventilation, or the like. In an example, determining a frequency of chest compressions may be based at least in part on a known or predetermined average compression frequency or range of frequencies, such as a range of 100 to 120 compressions per minute. In some examples, the determining a frequency of chest compressions may be based on identifying peak (e.g., maximum) amplitudes or minimum amplitudes in the identified compression artifacts 202, 204, 206 and determining a statistic (e.g., an average) based on the amount of time between each max/min amplitude in the compression artifact 202, 204, 206. For example, the frequency of the peak amplitudes in the compression artifacts 202, 204, 206 may correspond to, and, hence, may be used to determine the frequency of chest compressions that are being administered to the subject 104. A count (or a number) of the chest compressions may be determined by counting these max/min amplitudes. In some examples, the processor(s) 116 of the ventilation device 112 is configured to track the timing of when ventilations (e.g., PPVs) are administered to the subject 104. Accordingly, the processor(s) 116 may be configured to determine a time at which a last ventilation was administered, and the processor(s) 116 can count the number of the chest compressions that have been consecutively administered to the subject 104 since the last ventilation. Accordingly, the processor(s) 116 may be configured to automate the counting of chest compressions during CPR in order to coach the rescuer(s) 102 as to when (e.g., a time at which) a ventilation (or PPV) should be administered to the subject 104. If the chest compression count satisfies a threshold (e.g., a threshold of 30 compressions), the processor(s) 116 may cause coaching information to be output via the output device 126 (e.g., a display) of the ventilation device 112. Such coaching information may indicate a timing of administering a ventilation to the subject 104 via the ventilation device 112.

In general, any one or more of the chest compression parameter(s) that the processor(s) 116 determines from the compression artifact 202, 204, 206 may be analyzed and may trigger the processor(s) 116 to cause performance of an action(s), which may aid the rescuer(s) 102 and/or a device 106, 110, and/or 112 at the rescue scene 100, for example. In some examples, a separate compression feedback device and/or CPR feedback device may be monitoring chest compressions administered to the subject 104. An example of such a feedback device is the Philips® Q-CPR™ device. In some examples, the chest compression device 110 stores and/or monitors the parameters of the chest compressions that are administered to the subject 104 via the chest compression device 110. In these examples, the chest compression parameter(s) determined via the airway parameter(s) by the processor(s) 116 may be used to supplement the separate compression parameters determined by a compression/CPR feedback device and/or the chest compression device 110. For example, the chest compression parameter(s) determined via the airway parameter(s) by the processor(s) 116 may be compared with the chest compression parameters determined by the compression/CPR feedback device and/or the chest compression device 110 to determine a concordance (e.g., to confirm the accuracy of the separately-determined chest compression parameters) or a discordance (e.g., to identify a discrepancy between the two measurements, and, hence, a potential issue). For example, the compression monitoring capability of the ventilation device 112 may be used to determine if the compression/CPR feedback device and/or the chest compression device 110 needs to be calibrated and/or if the device is not setup or configured properly and/or if the device has become detached from the subject 104 during a rescue effort.

In some examples, the compression monitoring capability of the ventilation device 112 may be used to evaluate the quality of CPR that is being administered to the subject 104. That is, the chest compression parameter(s) determined via the airway parameter(s) by the processor(s) 116 can be used to provide feedback (e.g., the rescuer(s) 102, the chest compression device 110, etc.) as to whether CPR is effective and adequate. For example, the CO₂ parameter(s) (e.g., partial pressure of CO₂) detected by the airway sensor(s) 118 and/or the sensor(s) 108 may be indicative of the subject's response to CPR. For example, if the subject's body is converting oxygen to CO₂ as expected for a good response to CPR, this can indicate that the subject 104 is responding well to the CPR, and the processor(s) 116 may cross-correlate the compression parameter(s) (e.g., frequency of chest compressions, depth of chest compressions, etc.) with the CO₂ data (e.g., the CO₂ waveform) to determine the quality of the CPR being administered. In some examples, other airway parameters, such as airflow parameters, air pressure parameters, or the like, may be analyzed to determine the quality of CPR that is being administered to the subject 104. For example, if the volume of air moving out of the lungs (e.g., expired air) is at an expected level, this may provide further confirmation that high-quality CPR is being administered to the subject 104. In some examples, the processor(s) 116 is configured to analyze long-term trends to determine whether the CO₂ parameter (e.g., partial pressure of CO₂) is increasing or decreasing, which may be indicative of CPR quality. In some examples, information relating to the CPR quality determined by the processor(s) 116 may be output via an output device 126 for real-time feedback to the rescuer 102, and/or data can be transmitted (e.g., uploaded) to a remote computing system for post-processing analysis to improve rescuer training over time.

The processes described herein represent sequences of operations that can be implemented in hardware, software, or a combination thereof. In the context of software, the blocks represent computer-executable instructions stored on one or more computer-readable storage media that, when executed by a processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, an operation(s) of the process may be omitted entirely. Moreover, the processes described herein can be combined in whole or in part with each other or with other processes.

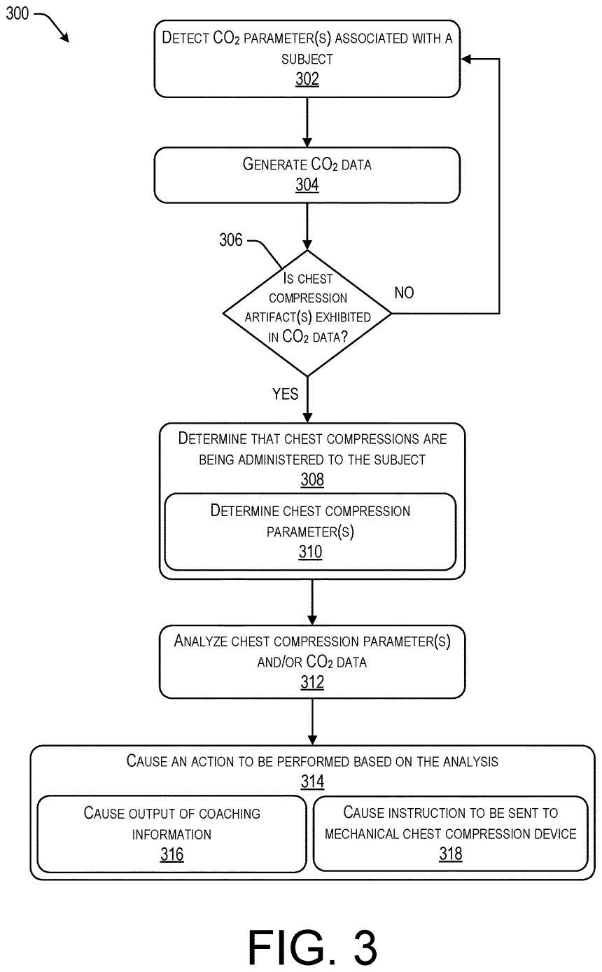

FIG. 3 illustrates an example process 300 for performing an action based on an analysis of one or more chest compression parameters determined from a chest compression artifact 202, 204, 206 exhibited in CO₂ data, according to the techniques described herein. For discussion purposes, the process 300 is described with reference to the previous figures.

At 302, a CO₂ parameter associated with a subject 104 is detected. The CO₂ parameter may be detected at block 302 by a sensor, such as an airway sensor 118, which may be a component of, or an accessory to, a ventilation device 112 that is being used to ventilate the subject 104 as part of CPR that is being administered to the subject 104. Additionally, or alternatively, the CO₂ parameter may be detected at block 302 by a sensor(s) 108 associated with a monitor-defibrillator 106. In some examples, the CO₂ parameter detected at block 302 is a partial pressure of CO₂ in the airway of the subject 104.

At 304, CO₂ data indicating the CO₂ parameter is generated. The CO₂ data may be generated at block 304 by a processor(s) 116, which may be a component of the ventilation device 112. For example, the processor(s) 116 may receive or otherwise determine values of the CO₂ parameter detected by the sensor (e.g., the airway sensor 118) over time and may generate the CO₂ data as a time series of CO₂ parameter values. The method 300 may exclude the step 302 of detecting the CO₂ parameter, if the CO₂ parameter, or information representative thereof, is received by the processor(s) 116. In some examples, CO₂ data generated at block 304 is a CO₂ waveform (e.g., a capnogram) indicating the partial pressure of CO₂. Examples of such CO₂ waveforms are shown in FIG. 2 via the capnograms 200(1)-(4) with values of the partial pressure of CO₂ (expressed in units of millimeters of mercury (mmHg)) plotted over time.

At 306, a determination is made as to whether a chest compression artifact(s) is exhibited in the CO₂ data generated at block 304. The determination may be made at block 306 by the processor(s) 116. In some examples, the processor(s) 116 is configured process (e.g., analyze) the CO₂ data in various ways, such as by analyzing and/or searching a CO₂ waveform for a portion(s) that satisfies a threshold frequency and/or a portion(s) with an amplitude that varies by more than a threshold amount in an attempt to identify a chest compression artifact(s). This could be done via image analysis of a capnogram 200(1)-(4) and/or by processing raw CO₂ data, such as by processing a time series of CO₂ parameter values. If no chest compression artifacts are identified in the CO₂ data, the process 300 follows the NO route from block 306 back to block 302 where additional CO₂ parameters may be detected, such as during an ongoing rescue effort at a rescue scene 100. If the processor(s) 116 identifies a chest compression artifact(s) 202, 204, 206 exhibited in the CO₂ data (e.g., the CO₂ waveform), the process 300 follows the YES route from block 306 to block 308.

At 308, a determination is made that chest compressions are being administered to the subject 104. For example, the processor(s) 116 may identify a relatively high frequency signal exhibited in the CO2 data, which can indicate that chest compressions are being administered to the subject 104. Examples of compression artifacts 202, 204, 206 that may lead to the determination at block 308 are shown in the capnograms 200(2), 200(3), 200(4) of FIG. 2.

At 310, a chest compression parameter(s) associated with the chest compressions that are being administered to the subject 104 is determined. The chest compression parameter(s) may be determined at block 310 by the processor(s) 116 based on the chest compression artifact(s) exhibited in the CO₂ data. The chest compression parameter(s) determined at block 310 may include any suitable parameter, such as a frequency or rate of the chest compressions, a rhythm of the chest compressions, a pattern of the chest compressions, a position of the chest compressions (e.g., relative to the body of the subject 104), a timing of the chest compressions (e.g., a timestamp, a relative timing of the compressions relative to another event(s), etc.), a depth of the chest compressions, a force of the chest compressions, a number of consecutively-administered chest compressions (e.g., a count, a running total, etc.), such as a number of consecutively-administered chest compressions since a last ventilation, or the like. In an example, determining a frequency of chest compressions at block 310 may be based at least in part on a known or predetermined average compression frequency or range of frequencies, such as a range of 100 to 120 compressions per minute. In some examples, the determining a frequency of chest compressions at block 310 may be based on identifying peak amplitudes in the identified compression artifacts 202, 204, 206 and determining a statistic (e.g., an average) based on the amount of time between each peak amplitude in the compression artifact 202, 204, 206. In other words, the frequency of the peak amplitudes in the compression artifacts 202, 204, 206 may correspond to, and, hence, may be used to determine, the frequency of chest compressions that are being administered to the subject 104. In some examples, a frequency of the chest compressions may be determined at block 310 by performing a spectral analysis (e.g., by computing a power spectral density (PSD) of the capnogram and identifying a peak (e.g., maximum) frequency in the computed PSD curve. In another example, a count (or a number) of the chest compressions may be determined at block 310 by counting the max/min amplitudes of the identified chest compression artifact 202, 204, 206.

At 312, the chest compression parameter(s) determined at block 310 and/or the CO₂ data generated at block 304 is analyzed. The compression parameter(s) and/or the CO₂ data may be analyzed at block 312 by the processor(s) 116, such as by comparing values to one or more thresholds, predetermined value ranges, computing statistics based on the data, using rules, models (e.g., machine learning models), or the like.

At 314, an action(s) is caused to be performed based on the analysis of the chest compression parameter(s) and/or the CO₂ data. The processor(s) 116 may cause the performance of the action(s) at block 314. In some examples, the action performed at block 314 may be causing compression feedback to be sent to another device at a rescue scene 100 and/or a remote computing system. For instance, the chest compression parameter(s) determined via the CO₂ parameter(s) may be used to supplement the separate compression parameters determined by a compression/CPR feedback device and/or the chest compression device 110. For example, the chest compression parameter(s) determined via the CO₂ parameter(s) may be compared with the chest compression parameters determined by the compression/CPR feedback device and/or the chest compression device 110 to determine a concordance (e.g., to confirm the accuracy of the separately-determined chest compression parameters) or a discordance (e.g., to identify a discrepancy between the two measurements, and, hence, a potential issue), and the action(s) performed at block 314 may be to send feedback data to another device(s) regarding the determined concordance or discordance. This feedback data may be used to determine if the compression/CPR feedback device and/or the chest compression device 110 needs to be calibrated and/or if the device is not setup or configured properly and/or if the device has become detached from the subject 104 during a rescue effort. Additional exemplary actions that may be performed at block 314 are discussed with reference to blocks 316 and 318.

At 316, as an example of an action that can be performed at block 314, the processor(s) 116 may cause coaching information to be output via an output device based on the analysis of the chest compression parameter(s) and/or the CO₂ data. For example, the coaching information may be output via the output device(s) 126 of the ventilation device 112. That is, the ventilation device 112 may function, in part, as a coaching device to coach a rescuer 102 who may be performing CPR at a rescue scene 100, where chest compressions may be administered manually by the rescuer 102 or via the chest compression device 110 shown in FIG. 1. As CPR is being performed, the coaching information output to the rescuer 102 may coach the rescuer 102 as to when, how, and/or where to administer ventilation breaths and/or chest compressions. In some examples, the coaching information may be output at block 316 to help the rescuer 102 adhere to a CPR protocol, such as a 30:2 CPR protocol where 20 compressions are to be consecutively administered followed by 2 ventilations, and the cycle repeats. In some examples, the coaching information may be output at block 316 to detect that chest compressions are being administered when they shouldn't be and to coach the rescuer 102 to cease administering chest compressions. In some examples, analysis of the CO₂ data may result in a determination that a value of the CO₂ parameter (e.g., the partial pressure of CO₂) is low (e.g., fails to satisfy a threshold) or is at zero, which may indicate that the depth of compressions is too shallow and/or that the subject 104 is otherwise not getting enough circulation. Accordingly, the coaching information output at block 316 may coach the rescuer 102 to adjust a depth of the chest compressions. In some examples, the coaching information output at block 316 may include a recommendation, such as a recommendation that reads “we think you're getting tired, consider switching roles.” In some examples, the analysis performed at block 312 may include comparing the chest compression parameter(s) with the CO₂ data to determine analysis results such as a quality of CPR that is being administered to the subject 104, as described above. Accordingly, the coaching information output at block 316 may be based at least in part on the quality of CPR determined based on the analysis.

At 318, as another example of an action that can be performed at block 314, the processor(s) 116 may cause an instruction to be sent to the mechanical chest compression device 110, such as an instruction to start or stop compressions, and/or to adjust a parameter(s) of the compressions. It is to be appreciated that the chest compression device 110 can be instructed in a similar manner to how the rescuer 102 can be coached via the coaching information, at least with respect to the administration of chest compressions. Accordingly, even though the chest compression device 110 may store, track, and/or monitor compression parameters independently of the ventilation device 112, the ventilation device 112 can assist the chest compression device 110, in some examples, such as by sending instructions to the chest compression device 110 at block 318 to indicate when, how, and/or where to administer chest compressions to the subject 104, such as by instructing the chest compression device 110 to temporarily cease compressions while ventilations are administered to the subject 104 in accordance with a CPR protocol, such as a 30:2 CPR protocol In some examples, analysis of the CO₂ data may result in a determination that a value of the CO₂ parameter (e.g., the partial pressure of CO₂) is low (e.g., fails to satisfy a threshold) or is at zero, which may indicate that the depth of compressions is too shallow and/or that the subject 104 is otherwise not getting enough circulation. Accordingly, the processor(s) 116 may cause an instruction to be sent to the mechanical chest compression device 110 at block 318 to adjust a depth of the chest compressions.

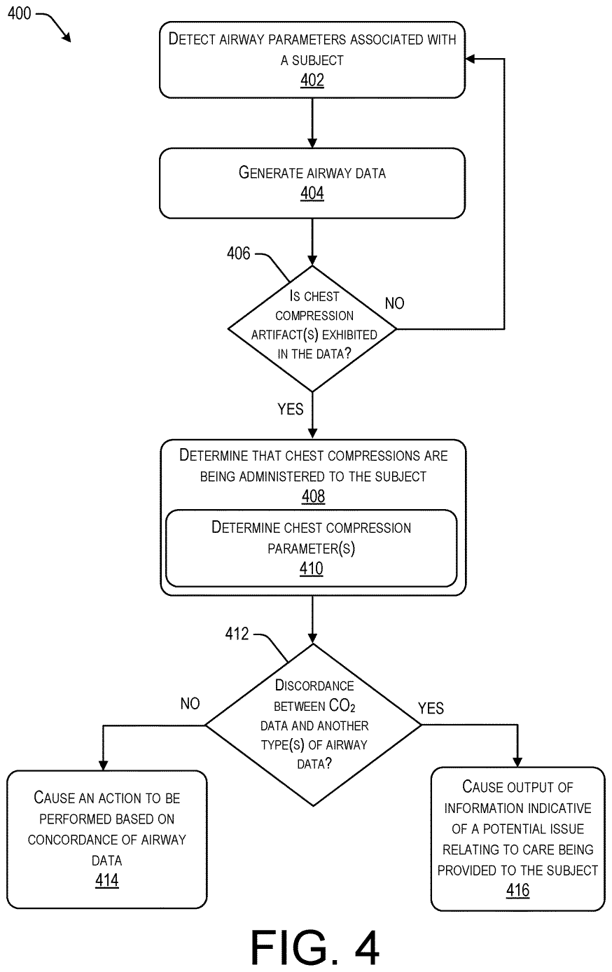

FIG. 4 illustrates an example process 400 for performing an action based on a concordance or a discordance between CO₂ data and another type(s) of airway data associated with a subject, according to the techniques described herein. For discussion purposes, the process 400 is described with reference to the previous figures.

At 402, airway parameters associated with an airway of a subject 104 are detected. The airway parameters may be detected at block 402 by a sensor(s). At least some of the airway parameters may be detected at block 402 by an airway sensor 118, which may be a component of, or an accessory to, a ventilation device 112 that is being used to ventilate the subject 104 as part of CPR that is being administered to the subject 104.

Additionally, or alternatively, At least some of the airway parameters may be detected at block 402 by a sensor(s) 108 associated with a monitor-defibrillator 106. In some examples, the airway parameters detected at block 402 include a CO₂ parameter associated with the subject 104 (e.g., a partial pressure of CO₂ in the airway of the subject 104) and another airway parameter(s) associated with the airway of the subject 104, wherein the other airway parameter is different than the CO₂ parameter. Examples of other airway parameters that are different than the CO₂ parameter include airflow parameters associated with air flowing in a fluidic circuit including the airway of the subject 104, such as a flow rate of air flowing in a fluidic circuit including the airway of the subject 104, air pressure parameters associated with the airway of the subject 104, such as a pressure (e.g., PEEP, plateau pressure, PIP, etc.) associated with the airway of the subject 104.

At 404, airway data is generated. The airway data may be generated at block 404 by a processor(s) 116, which may be a component of the ventilation device 112. The airway data generated at block 404 may include CO₂ data (e.g., a CO₂ waveform) indicating the CO₂ parameter (e.g., partial pressure of CO₂), as well as additional airway data indicating the airway parameter different than the CO₂ parameter, such as airflow data indicating the airflow parameter (e.g., the flow rate of the air flowing in a fluidic circuit including the airway of the subject 104) and/or air pressure data indicating the air pressure parameter (e.g., the pressure associated with the airway of the subject 104). For example, the processor(s) 116 may receive or otherwise determine values of the airway parameter different than the CO₂ parameter, such as the airflow parameter(s) and/or air pressure parameter(s), detected by the sensor. The method 400 may exclude the step 402 of detecting the airway parameter different than the CO₂ parameter, such as the airflow parameter(s) and/or air pressure parameter(s), if the airway parameter, or information representative thereof, is received by the processor(s) 116.

At 406, a determination is made as to whether a chest compression artifact(s) is exhibited in airway data generated at block 404. The determination may be made at block 406 by the processor(s) 116. In some examples, the processor(s) 116 is configured process (e.g., analyze) the airway data in various ways, as described herein, such as via image analysis, by processing raw airway data (e.g., a time series of airway parameter values), or the like. In some examples, multiple types of airway data associated with different airway parameters are analyzed at block 406 to make the determination (e.g., with higher confidence, as compared to basing the determination on a single type of airway data). For example, artifacts can be exhibited in airway data from various sources. Such artifacts may be caused by chest compressions, or by another source, such as vibrations of a moving vehicle (e.g., an ambulance). Accordingly, at block 406, CO₂ data (e.g., the CO₂ waveform) may be used as a primary signal for identifying a chest compression artifact(s), and other airway data, such as airflow data and/or air pressure data may be used as a secondary signal to confirm and/or validate the detection of chest compressions via the primary signal. For example, if a first chest compression artifact is identified in CO2 data at block 406, and a second chest compression artifact identified in the airflow data (and/or if a second or third chest compression artifact is identified in the air pressure data) at block 406, the identification of multiple compression artifacts via multiple different types of airway parameters may increase the confidence of a determination at block 406 that chest compressions are the cause of the artifacts. If no chest compression artifacts are identified in the airway data, the process 400 follows the NO route from block 406 back to block 402 where additional airway parameters may be detected, such as during an ongoing rescue effort at a rescue scene 100. If the processor(s) 116 identifies a chest compression artifact(s) exhibited in the airway data, the process 400 follows the YES route from block 406 to block 408.

At 408, a determination is made that chest compressions are being administered to the subject 104. This determination may be similar to the determination described above with respect to block 308 of the process 300. In some examples, the determination at block 408 may be based on multiple compression artifacts identified via multiple different types of airway parameters, such as the CO₂ parameter, the airflow parameter, and/or the air pressure parameter, as described above.

At 410, a chest compression parameter(s) associated with the chest compressions that are being administered to the subject 104 is determined. This determination may be similar to the determination described above with respect to block 310 of the process 300.

At 412, a determination is made as to whether there is a discordance between the CO₂ data and the additional airway data indicating the airway parameter different than the CO₂ parameter, such as airflow data indicating the airflow parameter (e.g., the flow rate of the air flowing in a fluidic circuit including the airway of the subject 104) and/or air pressure data indicating the air pressure parameter (e.g., the pressure associated with the airway of the subject 104). A discordance, if determined at block 412, may be indicative of a potential issue relating to the care that is being provided to the subject, such as an air leak associated with the ventilation device and/or an inadequate seal of a mask around the subject's nose and mouth. An example of such discordance is a scenario where airflow data indicates that air is flowing at an expected flow rate(s) via the subject's airway, but the CO₂ data indicates a lower-than-expected partial pressure of CO₂. Airflow without, or with lower-than-expected, partial pressure of CO₂ can indicate that the air is coming from somewhere else, which may be caused by an air leak and/or an inadequate seal between the mask and the subject's face, or an inadvertent inflation of the subject's stomach with air, and/or an incorrect insertion a tube via the subject's oral cavity (e.g., the air detected by the airway sensor(s) 118 may be a mixture of air expired from the lungs and air expired from the stomach). Another example of a discordance may be a deviation between airflow parameter and CO₂ parameter wherein the value of the airflow parameter is substantially consistent over a period of time, but the value of the CO₂ concentration gradually decreases, which may be indicative of the quality of CPR (e.g., depth of compressions are too shallow). Another example of a discordance may be a time interval between a first peak in the CO₂ data and a second peak in the additional airway data (e.g., the time interval satisfying a threshold time interval). A concordance between the CO₂ data and the additional airway data may indicate that CPR is being administered as expected and that the subject 104 is stable and/or recovering. For instance, a certain level of CO₂ concentration in the air moving through the airway of the subject 104 may confirm that the air is coming from the lungs when the CO₂ data is cross-correlated with the additional airway data.

If, at block 412, there is a concordance between the CO₂ data and the additional airway data, the process 400 follows the NO route from block 412 to block 414, where an action(s) is caused to be performed based on the concordance of the airway data. The action(s) performed at block 414 may be similar to at least some of the exemplary actions described above at block 314 of the process 300, such as outputting coaching information and/or sending an instruction to the chest compression device 110, if the device 110 is being used during the rescue effort. If, at block 412, there is a discordance between the CO₂ data and the additional airway data, the process 400 follows the YES route from block 412 to block 416.

At 416, information is caused to be output via an output device based on determining the discordance at block 412. The processor(s) 116 may cause the information to be output at block 416, such as via an output device(s) 126 (e.g., a display) of the ventilation device 112. The information output at block 416 may be indicative of a potential issue relating to care being provided to the subject 104. For example, the information may include a recommendation to check for an air leak associated with the ventilation device 112, and/or a recommendation relating to CPR that is being administered to the subject 104, such as a recommendation is to adjust a depth of the chest compressions or a frequency of the chest compressions. Accordingly, the rescuer may take appropriate action(s) to address a potential issue. In some examples, the discordance determined at block 412 may be based on a determination that a first value of the airway parameter (e.g., airflow parameter and/or air pressure parameter) satisfies a first threshold, and a determination that a second value of the CO₂ parameter (e.g., the partial pressure of CO₂) fails to satisfy a second threshold, which may indicate that there is airflow, but that CO₂ have dropped below an expected level. In this scenario, the information output at block 416 may be based on the discordance determined using the multiple different thresholds in association with the multiple different airway parameters. In some examples, the information output at block 416 is based on an analysis of the chest compression parameter(s) determined at block 410. For example, the processor(s) 116 may determine, based on the chest compression artifact(s), a number of the chest compressions that have been consecutively administered to the subject 104 (e.g., since the last ventilation), determine that the number of the chest compressions satisfies a first threshold, and in response to the determining that the number of the chest compressions satisfies the first threshold, determine that a value of the CO₂ parameter detected by the sensor at block 402 fails to satisfy a second threshold, which could indicate an air leak or an improper mask seal right before the rescuer 102 is about to ventilate the subject 104. If the chest compression device 110 is being used during the rescue effort to administer chest compressions to the subject 104, the processor(s) 116 may, in some examples, send an instruction to the device 110 to adjust a depth of the chest compressions or a frequency of the chest compressions. augment

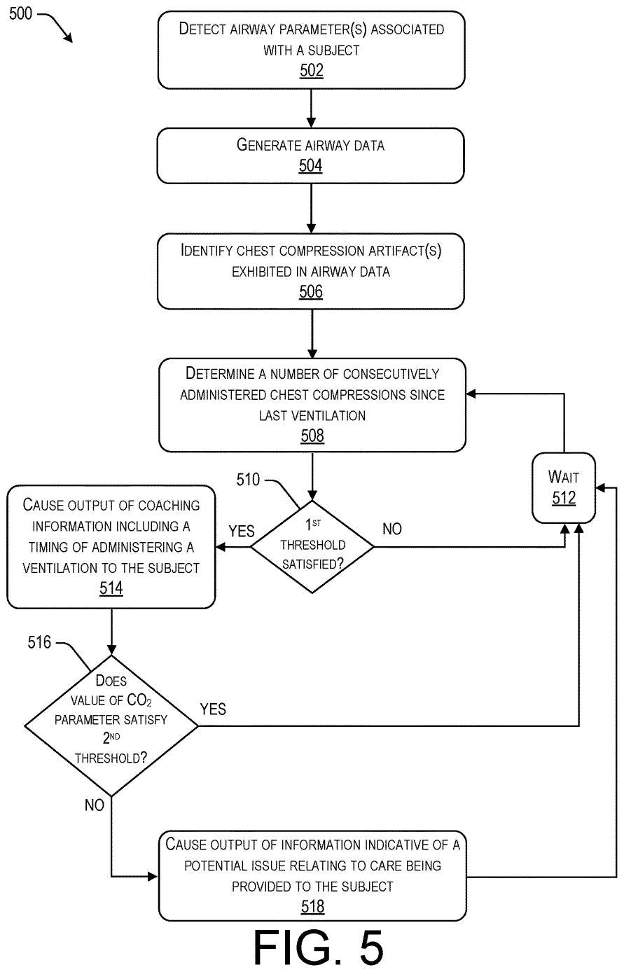

FIG. 5 illustrates an example process 500 for ventilation coaching based on compression analysis via airway parameters, according to the techniques described herein. For discussion purposes, the process 500 is described with reference to the previous figures.

At 502, one or more airway parameters associated with an airway of a subject 104 are detected. The airway parameters may be detected at block 502 by a sensor(s). At least some of the airway parameters may be detected at block 502 by an airway sensor 118, which may be a component of, or an accessory to, a ventilation device 112 that is being used to ventilate the subject 104 as part of CPR that is being administered to the subject 104. Additionally, or alternatively, At least some of the airway parameters may be detected at block 502 by a sensor(s) 108 associated with a monitor-defibrillator 106. In some examples, the airway parameters detected at block 502 include one or more of a CO₂ parameter associated with the subject 104 (e.g., a partial pressure of CO₂ in the airway of the subject 104), an airflow parameter associated with air flowing in a fluidic circuit including the airway of the subject 104, such as a flow rate of air flowing in a fluidic circuit including the airway of the subject 104, an air pressure parameter associated with the airway of the subject 104, such as a pressure (e.g., PEEP, plateau pressure, PIP, etc.) associated with the airway of the subject 104, or any other suitable airway parameter. For example, the processor(s) 116 may receive or otherwise determine values of the detected airway parameters. The method 500 may exclude the step 502 of detecting the airway parameters, if the airway parameters, or information representative thereof, are received by the processor(s) 116.

At 504, airway data is generated. The airway data may be generated at block 504 by a processor(s) 116, which may be a component of the ventilation device 112. The airway data generated at block 504 may include CO₂ data (e.g., a CO₂ waveform) indicating the CO₂ parameter (e.g., partial pressure of CO₂), airflow data indicating the airflow parameter (e.g., the flow rate of the air flowing in a fluidic circuit including the airway of the subject 104), and/or air pressure data indicating the air pressure parameter (e.g., the pressure associated with the airway of the subject 104).

At 506, a chest compression artifact(s) exhibited in the airway data generated at block 504 is identified, as described herein. The identification of the compression artifact(s) at block 506 may include performing operations such as those described above with respect to blocks 306 and/or 406 of the processes 300 and 400, respectively.

At 508, a number of chest compressions that have been consecutively administered to the subject 104 is determined. The number (or count) of compressions may be determined at block 508 by the processor(s) 116 based on the chest compression artifact(s) exhibited in the airway data (e.g., the CO₂ data). In some examples, a count (or a number) of the chest compressions may be determined at block 508 by counting the maximum amplitudes (i.e., peaks) or minimum amplitudes in the identified compression artifact(s) 202, 204, 206. In some examples, the processor(s) 116 of the ventilation device 112 is configured to track the timing of when ventilations (e.g., PPVs) are administered to the subject 104. Accordingly, the processor(s) 116 may be configured to determine a time at which a last ventilation was administered, and the processor(s) 116 can count the number of the chest compressions that have been consecutively administered to the subject 104 since the last ventilation at block 508.

At 510, a determination is made as to whether the number of the chest compressions satisfies a (first) threshold. In an example where a 30:2 CPR protocol is being followed during a rescue effort, this threshold may be a threshold of 30 compressions. If the (first) threshold is not satisfied at block 510, the process 500 follows the NO route from block 510 to block 512 where the processor(s) 116 may wait and, after waiting, determine (or recalculate), at block 508, the number of chest compressions that have been consecutively administered to the subject 104. Assuming chest compressions continue to be administered and exhibited in the airway data, when the (first) threshold is satisfied (e.g., when the number of chest compressions reaches or exceeds the (first) threshold), the process 500 follows the YES route from block 510 to block 514.

At 514, coaching information is caused to be output via an output device based on the number of the chest compression satisfying the (first) threshold, wherein the coaching information comprises a timing of administering a ventilation to the subject 104 via the ventilation device 112. For example, the processor(s) 116 may cause a countdown timer to be output via the output device(s) 126 (e.g., a display) to indicate to the rescuer 102 a time at which the subject 104 should be ventilated and/or a number of ventilations (or PPVs) to administer and when to administer the ventilations. Accordingly, the process 500 may automate the counting of chest compressions during CPR in order to coach the rescuer(s) 102 as to when (e.g., a time at which) a ventilation (or PPV) should be administered to the subject 104.

At 516, in some examples, in response to the determining that the number of the chest compressions satisfies the first threshold (e.g., following the YES route from block 510), a value of a CO₂ parameter detected at block 502 may be evaluated, such as to detect a potential air leak. The process 500 may wait until the first threshold is satisfied to evaluate the value of a CO₂ parameter because it may be more useful to detect an air leak moments before the subject 104 is about to be ventilated, as opposed to earlier in the series of chest compressions. If the value of the CO₂ parameter satisfies the second threshold, the process 500 follows the YES route from block 516 to block 512 where the processor(s) 116 may wait and, after waiting, determine (or recalculate), at block 508, the number of chest compressions that have been consecutively administered to the subject 104 to iterate the ventilation coaching described above. If the value of the CO₂ parameter fails to satisfy the second threshold, the process 500 follows the NO route from block 516 to block 518.

At 518, the processor(s) 116 may cause information to be output via an output device(s) 126 (e.g., a display) of the ventilation device 112, the information indicative of a potential issue relating to care being provided to the subject 104, such as a potential air leak. This information may be output as part of the coaching information output at block 514 in scenarios where the process follows the NO route from block 516. Following block 518, the process 500 proceeds to block 512 where the processor(s) 116 may wait and, after waiting, determine (or recalculate), at block 508, the number of chest compressions that have been consecutively administered to the subject 104 to iterate the ventilation coaching described above.

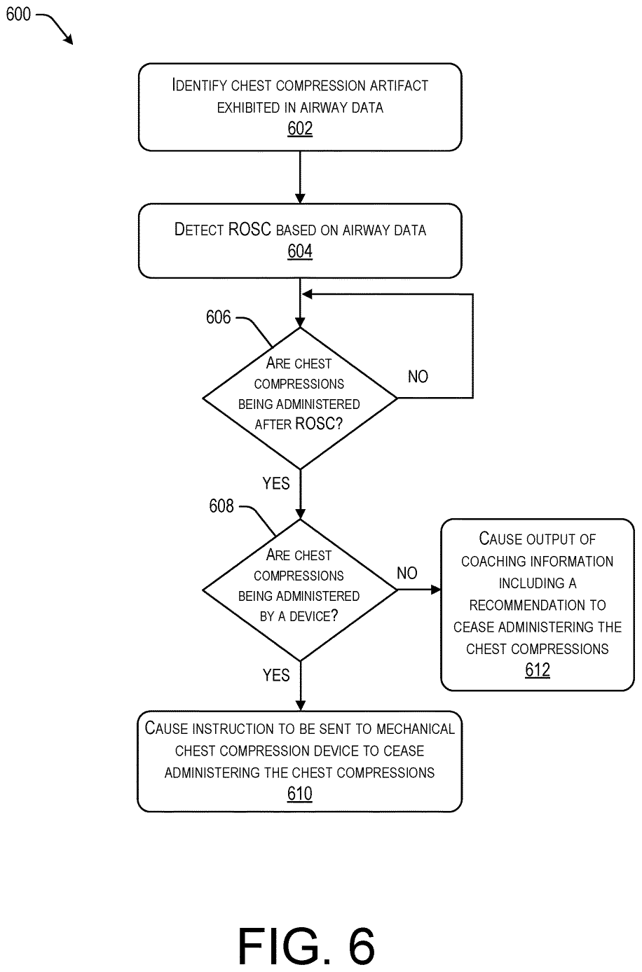

FIG. 6 illustrates an example process 600 for coaching or controlling CPR based on compression analysis via airway parameters, according to the techniques described herein. For discussion purposes, the process 600 is described with reference to the previous figures.

At 602, a chest compression artifact(s) exhibited in the airway data generated is identified, as described herein. The identification of the compression artifact(s) at block 506 may include performing operations such as those described above with respect to blocks 306 and/or 406 of the processes 300 and 400, respectively.

At 604, a return of spontaneous circulation (ROSC) associated with the subject 104 is detected based on the airway data (e.g., CO₂ data). The ROSC may be detected at block 604 by a processor(s) 116, which may be a component of the ventilation device 112. In some examples, the airway data that is analyzed to detect the ROSC is a CO₂ waveform (e.g., of a capnogram). ROSC is often associated with a sudden rise in EtCO₂. Accordingly, the detection of ROSC may involve searching for such a sudden rise in the CO₂ waveform that indicates the partial pressure of CO₂ associated with the subject's airway.

At 606, a determination is made as to whether chest compressions are being administered to the subject 104 after the ROSC. For example, the processor(s) 116 may analyze the timing of the chest compressions a relative to the time of the detected ROSC to determine whether the chest compressions are being administered when they shouldn't be (e.g., after the onset of ROSC). If the processor(s) 116 determines that the chest compressions are not being administered to the subject 104 after the ROSC, the process 600 follows the NO route from block 606 to continue monitoring for chest compressions administered after the ROSC. If the processor(s) 116 determines that one or more chest compressions are being administered to the subject 104 after the ROSC, the process 600 follows the YES route from block 606 to block 608.

At 608, if a mechanical chest compression device 110 is administering the chest compressions to the subject 104, the process 600 follows the YES route from block 608 to block 610, where an instruction is caused to be sent to the chest compression device 110 to cease administering the chest compressions. In other words, the processor(s) 116 may cause an instruction to be transmitted to the chest compression device 110 to emergency stop the device 110 from continuing to administer the chest compressions. If a mechanical chest compression device 110 is not administering the chest compressions to the subject 104, and the chest compressions are being administered manually by a rescuer 102, the process 600 follows the NO route from block 608 to block 612, where coaching information is caused to be output via an output device, such as the output device 126 of the ventilation device 112. This coaching information may include a recommendation to cease administering the chest compressions. In some examples, the processor(s) 116 may cause the output of coaching information at block 612 in the form of an alert, such as an alert that reads “ROSC detected, stop chest compressions!”

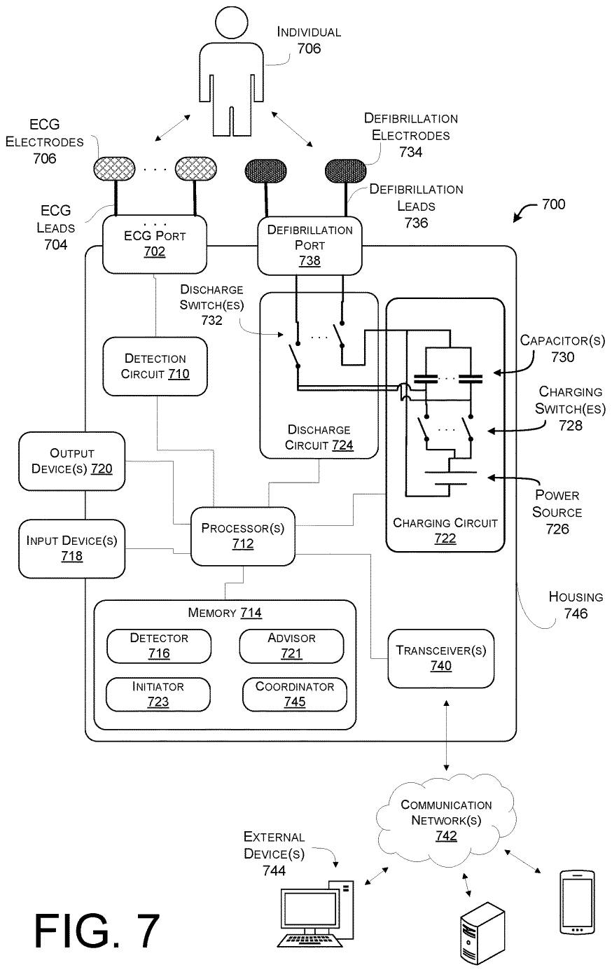

FIG. 7 illustrates an example of an monitor-defibrillator 700 (sometimes referred to herein as an “external defibrillator 700”) configured to perform various functions described herein. For example, the external defibrillator 700 is the monitor-defibrillator 106 described above and introduced in FIG. 1.

The external defibrillator 700 includes an electrocardiogram (ECG) port 702 connected to multiple ECG leads 704. In some cases, the ECG leads 704 are removeable from the ECG port 702. For instance, the ECG leads 704 are plugged into the ECG port 702. The ECG leads 704 are connected to ECG electrodes 706, respectively. In various implementations, the ECG electrodes 706 are disposed on different locations on an individual 708 (sometimes referred to herein as a “subject 708”, or a “patient 708”). A detection circuit 710 is configured to detect relative voltages between the ECG electrodes 706. These voltages are indicative of the electrical activity of the heart of the individual 708.

In various implementations, the ECG electrodes 706 are in contact with the different locations on the skin of the individual 708. In some examples, a first one of the ECG electrodes 706 is placed on the skin between the heart and right arm of the individual 708, a second one of the ECG electrodes 706 is placed on the skin between the heart and left arm of the individual 708, and a third one of the ECG electrodes 706 is placed on the skin between the heart and a leg (either the left leg or the right leg) of the individual 708. In these examples, the detection circuit 710 is configured to measure the relative voltages between the first, second, and third ECG electrodes 706. Respective pairings of the ECG electrodes 706 are referred to as “leads,” and the voltages between the pairs of ECG electrodes 706 are known as “lead voltages.” In some examples, more than three ECG electrodes 706 are included, such that 5-lead or 12-lead ECG signals are detected by the detection circuit 710.

The detection circuit 710 includes at least one analog circuit, at least one digital circuit, or a combination thereof. The detection circuit 710 receives the analog electrical signals from the ECG electrodes 706, via the ECG port 702 and the ECG leads 704. In some cases, the detection circuit 710 includes one or more analog filters configured to filter noise and/or artifact from the electrical signals. The detection circuit 710 includes an analog-to-digital (ADC) in various examples. The detection circuit 710 generates a digital signal indicative of the analog electrical signals from the ECG electrodes 706. This digital signal can be referred to as an “ECG signal” or an “ECG.”

In some cases, the detection circuit 710 further detects an electrical impedance between at least one pair of the ECG electrodes 706. For example, the detection circuit 710 includes, or otherwise controls, a power source that applies a known voltage (or current) across a pair of the ECG electrodes 706 and detects a resultant current (or voltage) between the pair of the ECG electrodes 706. The impedance is generated based on the applied signal (voltage or current) and the resultant signal (current or voltage). In various cases, the impedance corresponds to respiration of the individual 708, chest compressions performed on the individual 708, and other physiological states of the individual 708. In various examples, the detection circuit 710 includes one or more analog filters configured to filter noise and/or artifact from the resultant signal. The detection circuit 710 generates a digital signal indicative of the impedance using an ADC. This digital signal can be referred to as an “impedance signal” or an “impedance.”

The detection circuit 710 provides the ECG signal and/or the impedance signal one or more processors 712 in the external defibrillator 700. In some implementations, the processor(s) 712 includes a central processing unit (CPU), a graphics processing unit (GPU), both CPU and GPU, or other processing unit or component known in the art.

The processor(s) 712 is operably connected to memory 714. The memory 714 is volatile (such as random access memory (RAM)), non-volatile (such as read only memory (ROM), flash memory, etc.) or some combination of the two. The memory 714 stores instructions that, when executed by the processor(s) 712, causes the processor(s) 712 to perform various operations. In various examples, the memory 714 stores methods, threads, processes, applications, objects, modules, any other sort of executable instruction, or a combination thereof. In some cases, the memory 714 stores files, databases, or a combination thereof. In some examples, the memory 714 includes, but is not limited to, RAM, ROM, electrically erasable programmable read-only memory (EEPROM), flash memory, or any other memory technology. In some examples, the memory 714 includes one or more of CD-ROMs, digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 712 and/or the external defibrillator 700. In some cases, the memory 714 at least temporarily stores the ECG signal and/or the impedance signal.

In various examples, the memory 714 includes a detector 716, which causes the processor(s) 712 to determine, based on the ECG signal and/or the impedance signal, whether the individual 708 is exhibiting a particular heart rhythm. For instance, the processor(s) 712 determines whether the individual 708 is experiencing a shockable rhythm that is treatable by defibrillation. Examples of shockable rhythms include ventricular fibrillation (VF) and ventricular tachycardia (V-Tach). In some examples, the processor(s) 712 determines whether any of a variety of different rhythms (e.g., asystole, sinus rhythm, atrial fibrillation (AF), etc.) are present in the ECG signal.

The processor(s) 712 is operably connected to one or more input devices 718 and one or more output devices 720. Collectively, the input device(s) 718 and the output device(s) 720 function as an interface between a user and the defibrillator 700. The input device(s) 718 is configured to receive an input from a user and includes at least one of a keypad, a cursor control, a touch-sensitive display, a voice input device (e.g., a microphone), a haptic feedback device (e.g., a gyroscope), or any combination thereof. The output device(s) 720 includes at least one of a display, a speaker, a haptic output device, a printer, or any combination thereof. In various examples, the processor(s) 712 causes a display among the output device(s) 720 to visually output a waveform of the ECG signal and/or the impedance signal. In some implementations, the input device(s) 718 includes one or more touch sensors, the output device(s) 720 includes a display screen, and the touch sensor(s) are integrated with the display screen. Thus, in some cases, the external defibrillator 700 includes a touchscreen configured to receive user input signal(s) and visually output physiological parameters, such as the ECG signal and/or the impedance signal.

In some examples, the memory 714 includes an advisor 721, which, when executed by the processor(s) 712, causes the processor(s) 712 to generate advice and/or control the output device(s) 720 to output the advice to a user (e.g., a rescuer). In some examples, the processor(s) 712 provides, or causes the output device(s) 720 to provide, an instruction to perform CPR on the individual 708. In some cases, the processor(s) 712 evaluates, based on the ECG signal, the impedance signal, or other physiological parameters, CPR being performed on the individual 708 and causes the output device(s) 720 to provide feedback about the CPR in the instruction. According to some examples, the processor(s) 712, upon identifying that a shockable rhythm is present in the ECG signal, causes the output device(s) 720 to output an instruction and/or recommendation to administer a defibrillation shock to the individual 708.

The memory 714 also includes an initiator 723 which, when executed by the processor(s) 712, causes the processor(s) 712 to control other elements of the external defibrillator 700 in order to administer a defibrillation shock to the individual 708. In some examples, the processor(s) 712 executing the initiator 723 selectively causes the administration of the defibrillation shock based on determining that the individual 708 is exhibiting the shockable rhythm and/or based on an input from a user (received, e.g., by the input device(s) 718). In some cases, the processor(s) 712 causes the defibrillation shock to be output at a particular time, which is determined by the processor(s) 712 based on the ECG signal and/or the impedance signal.

The processor(s) 712 is operably connected to a charging circuit 722 and a discharge circuit 724. In various implementations, the charging circuit 722 includes a power source 726, one or more charging switches 728, and one or more capacitors 730. The power source 726 includes, for instance, a battery. The processor(s) 712 initiates a defibrillation shock by causing the power source 726 to charge at least one capacitor among the capacitor(s) 730. For example, the processor(s) 712 activates at least one of the charging switch(es) 728 in the charging circuit 722 to complete a first circuit connecting the power source 726 and the capacitor to be charged. Then, the processor(s) 712 causes the discharge circuit 724 to discharge energy stored in the charged capacitor across a pair of defibrillation electrodes 734, which are in contact with the individual 708. For example, the processor(s) 712 deactivates the charging switch(es) 728 completing the first circuit between the capacitor(s) 730 and the power source 726, and activates one or more discharge switches 732 completing a second circuit connecting the charged capacitor 730 and at least a portion of the individual 708 disposed between defibrillation electrodes 734.

The energy is discharged from the defibrillation electrodes 734 in the form of a defibrillation shock. For example, the defibrillation electrodes 734 are connected to the skin of the individual 708 and located at positions on different sides of the heart of the individual 708, such that the defibrillation shock is applied across the heart of the individual 708. The defibrillation shock, in various examples, depolarizes a significant number of heart cells in a short amount of time. The defibrillation shock, for example, interrupts the propagation of the shockable rhythm (e.g., VF or V-Tach) through the heart. In some examples, the defibrillation shock is 200 J or greater with a duration of about 0.015 seconds. In some cases, the defibrillation shock has a multiphasic (e.g., biphasic) waveform. The discharge switch(es) 732 are controlled by the processor(s) 712, for example. In various implementations, the defibrillation electrodes 734 are connected to defibrillation leads 736. The defibrillation leads 736 are connected to a defibrillation port 738, in implementations. According to various examples, the defibrillation leads 736 are removable from the defibrillation port 738. For example, the defibrillation leads 736 are plugged into the defibrillation port 738.

In various implementations, the processor(s) 712 is operably connected to one or more transceivers 740 that transmit and/or receive data over one or more communication networks 742. For example, the transceiver(s) 740 includes a network interface card (NIC), a network adapter, a local area network (LAN) adapter, or a physical, virtual, or logical address to connect to the various external devices and/or systems. In various examples, the transceiver(s) 740 includes any sort of wireless transceivers capable of engaging in wireless communication (e.g., radio frequency (RF) communication). For example, the communication network(s) 742 includes one or more wireless networks that include a 3^{rd} Generation Partnership Project (3GPP) network, such as a Long Term Evolution (LTE) radio access network (RAN) (e.g., over one or more LTE bands), a New Radio (NR) RAN (e.g., over one or more NR bands), or a combination thereof. In some cases, the transceiver(s) 740 includes other wireless modems, such as a modem for engaging in WI-FI®, WIGIG@, WIMAX®, BLUETOOTH®, NFC, radio frequency identification (RFID), or infrared communication over the communication network(s) 742.

The defibrillator 700 is configured to transmit and/or receive data (e.g., ECG data, impedance data, data indicative of one or more detected heart rhythms of the individual 708, data indicative of one or more defibrillation shocks administered to the individual 708, etc.) with one or more external devices 744 via the communication network(s) 742. The external devices 744 include, for instance, mobile devices (e.g., mobile phones, smart watches, etc.), Internet of Things (IoT) devices, medical devices, computers (e.g., laptop devices, servers, etc.), or any other type of computing device configured to communicate over the communication network(s) 742. In some examples, the external device(s) 744 is located remotely from the defibrillator 700, such as at a remote clinical environment (e.g., a hospital). According to various implementations, the processor(s) 712 causes the transceiver(s) 740 to transmit data to the external device(s) 744. In some cases, the transceiver(s) 740 receives data from the external device(s) 744 and the transceiver(s) 740 provide the received data to the processor(s) 712 for further analysis.

In some cases, the external device(s) 744 include the ventilation device 112 described above. According to various implementations, the memory 714 further includes a coordinator 745 that is configured to coordinate with the ventilation device 112. For example, the ventilation device 112 may implement compression analysis via airway parameters, as described above, and may transmit data to the external defibrillator 700, and the coordinator 745, when executed by the processor(s) 712, may cause information (e.g., coaching information) to be output via the output device(s) 720 based on the data received form the ventilation device 112. In other words, the information (e.g., coaching information) described above as being output based on the compression analysis, may be output via the output device(s) 720 of the external defibrillator 700. In some examples, the coordinator 745, when executed by the processor(s) 712, may coordinate the administration of defibrillation therapy to the individual 706 based on the data received from the ventilation device 112.

In various implementations, the external defibrillator 700 also includes a housing 746 that at least partially encloses other elements of the external defibrillator 700. For example, the housing 746 encloses the detection circuit 710, the processor(s) 712, the memory 714, the charging circuit 722, the transceiver(s) 740, or any combination thereof. In some cases, the input device(s) 718 and output device(s) 720 extend from an interior space at least partially surrounded by the housing 746 through a wall of the housing 746. In various examples, the housing 746 acts as a barrier to moisture, electrical interference, and/or dust, thereby protecting various components in the external defibrillator 700 from damage.

In some implementations, the external defibrillator 700 is an automated external defibrillator (AED) operated by an untrained user (e.g., a bystander, layperson, etc.) and can be operated in an automatic mode. In automatic mode, the processor(s) 712 automatically identifies a rhythm in the ECG signal, makes a decision whether to administer a defibrillation shock, charges the capacitor(s) 730, discharges the capacitor(s) 730, or any combination thereof. In some cases, the processor(s) 712 controls the output device(s) 720 to output (e.g., display 302) a simplified user interface to the untrained user. For example, the processor(s) 712 refrains from causing the output device(s) 720 to display a waveform of the ECG signal and/or the impedance signal to the untrained user, in order to simplify operation of the external defibrillator 700.

In some examples, the external defibrillator 700 is a monitor-defibrillator utilized by a trained user (e.g., a clinician, an emergency responder, etc.) and can be operated in a manual mode or the automatic mode. When the external defibrillator 700 operates in manual mode, the processor(s) 712 cause the output device(s) 720 to display a variety of information that may be relevant to the trained user, such as waveforms indicating the ECG data and/or impedance data, notifications about detected heart rhythms, and the like.

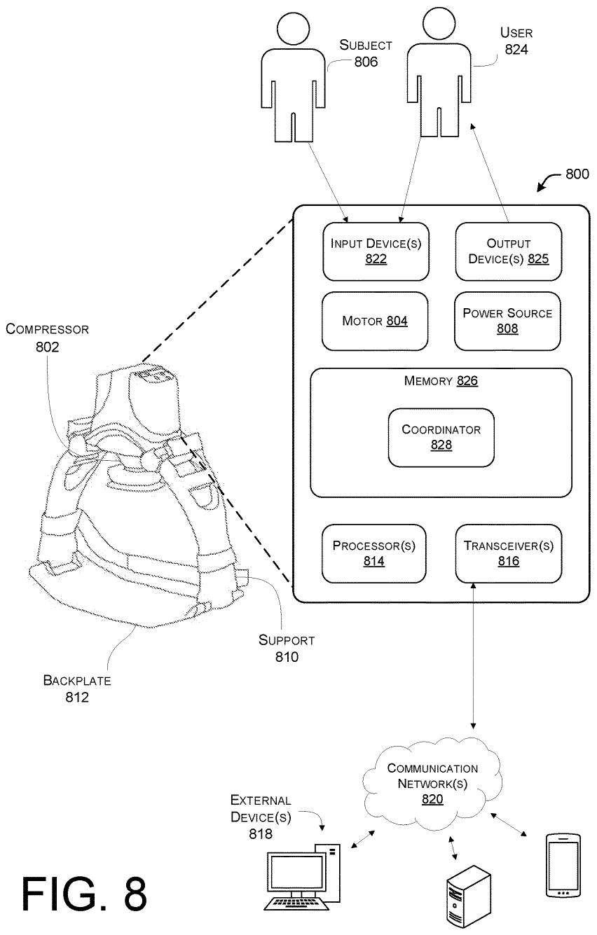

FIG. 8 illustrates a chest compression device 800 configured to perform various functions described herein. For example, the chest compression device 800 is the chest compression device 110 described above and introduced in FIG. 1.

In various implementations, the chest compression device 800 includes a compressor 802 that is operatively coupled to a motor 804. The compressor 802 physically administers a force to the chest of a subject 806 that compresses the chest of the subject 806. In some examples, the compressor 802 includes at least one piston that periodically moves between two positions (e.g., a compressed position and a release position) at a compression frequency. For example, when the piston is positioned on the chest of the subject 806, the piston compresses the chest when the piston is moved into the compressed position. A suction cup may be positioned on a tip of the piston, such that the suction cup contacts the chest of the subject 806 during operation. In various cases, the compressor 802 includes a band that periodically tightens to a first tension and loosens to a second tension at a compression frequency. For instance, when the band is disposed around the chest of the subject 806, the band compresses the chest when the band tightens.

The motor 804 is configured to convert electrical energy stored in a power source 808 into mechanical energy that moves and/or tightens the compressor 802, thereby causing the compressor 802 to administer the force to the chest of the subject 806. In various implementations, the power source 808 is portable. For instance, the power source 808 includes at least one rechargeable (e.g., lithium-ion) battery. In some cases, the power source 808 supplies electrical energy to one or more elements of the chest compression device 800 described herein.

In various cases, the chest compression device 800 includes a support 810 that is physically coupled to the compressor 802, such that the compressor 802 maintains a position relative to the subject 806 during operation. In some implementations, the support 810 is physically coupled to a backplate 812, cot, or other external structure with a fixed position relative to the subject 806. According to some cases, the support 810 is physically coupled to a portion of the subject 806, such as wrists of the subject 806.

The operation of the chest compression device 800 may be controlled by at least one processor 814. In various implementations, the motor 804 is communicatively coupled to the processor(s) 814. Specifically, the processor(s) 814 is configured to output a control signal to the motor 804 that causes the motor 804 to actuate the compressor 802. For instance, the motor 804 causes the compressor 802 to administer the compressions to the subject 806 based on the control signal. In some cases, the control signal indicates one or more treatment parameters of the compressions. Examples of treatment parameters include a frequency, timing, duty cycle, depth, force, position, velocity, height, and acceleration of the compressor 802 administering the compressions. According to various cases, the control signal causes the motor 804 to cease compressions.

In various implementations, the chest compression device 800 includes at least one transceiver 816 configured to communicate with at least one external device 818 over one or more communication networks 820. Any communication network described herein can be included in the communication network(s) 820 illustrated in FIG. 8. The external device(s) 818, for example, includes at least one of a monitor-defibrillator, an AED, an ECMO device, a ventilation device, a patient monitor, a mobile phone, a server, or a computing device. In some implementations, the transceiver(s) 816 is configured to communicate with the external device(s) 818 by transmitting and/or receiving signals wirelessly. For example, the transceiver(s) 816 includes a NIC, a network adapter, a LAN adapter, or a physical, virtual, or logical address to connect to the various external devices and/or systems. In various examples, the transceiver(s) 816 includes any sort of wireless transceivers capable of engaging in wireless communication (e.g., RF communication). For example, the communication network(s) 820 includes one or more wireless networks that include a 3GPP network, such as an LTE RAN (e.g., over one or more LTE bands), an NR RAN (e.g., over one or more NR bands), or a combination thereof. In some cases, the transceiver(s) 816 includes other wireless modems, such as a modem for engaging in WI-FI®, WIGIG®, WIMAX®, BLUETOOTH®, NFC, RFID, or infrared communication over the communication network(s) 820. The signals, in various cases, encode data in the form of data packets, datagrams, or the like. In some cases, the signals are transmitted as compressions are being administered by the chest compression device 800 (e.g., for real-time feedback by the external device(s) 818), after compressions are administered by the chest compression device 800 (e.g., for post-event review at the external device 818), or a combination thereof.

In various cases, the processor(s) 814 generates the control signal based on data encoded in the signals received from the external device(s) 818. For instance, the signals include an instruction to initiate the compressions, and the processor(s) 814 instructs the motor 804 to begin actuating the compressor 802 in accordance with the signals.

In some cases, the chest compression device 800 includes at least one input device 822. In various examples, the input device(s) 822 is configured to receive an input signal from a user 824, who may be a rescuer treating the subject 806. Examples of the input device(s) 822 include, for instance, at a keypad, a cursor control, a touch-sensitive display, a voice input device (e.g., a microphone), a haptic feedback device (e.g., a gyroscope), or any combination thereof. In various implementations, the processor(s) 814 generate the control signal based on the input signal. For instance, the processor(s) 814 generate the control signal to adjust a frequency of the compressions based on the chest compression device 800 detecting a selection by the user 824 of a user interface element displayed on a touchscreen or detecting the user 824 pressing a button integrated with an external housing of the chest compression device 800.

According to some examples, the input device(s) 822 include one or more sensors. The sensor(s), for example, is configured to detect a physiological parameter of the subject 806. In some implementations, the sensor(s) is configured to detect a state parameter of the chest compression device 800, such as a position of the compressor 802 with respect to the subject 806 or the backplate 812, a force administered by the compressor 802 on the subject 806, a force administered onto the backplate 812 by the body of the subject 806 during a compression, or the like. According to some implementations, the signals transmitted by the transceiver(s) 816 indicate the physiological parameter(s) and/or the state parameter(s).

The chest compression device 800 further includes at least one output device 825, in various implementations. Examples of the output device(s) 825 include, for instance, least one of a display (e.g., a projector, an LED screen, etc.), a speaker, a haptic output device, a printer, or any combination thereof. In some implementations, the output device(s) 825 include a screen configured to display various parameters detected by and/or reported to the chest compression device 800, a charge level of the power source 808, a timer indicating a time since compressions were initiated or paused, and other relevant information.

The chest compression device 800 further includes memory 826. In various implementations, the memory 826 is volatile (such as random access memory (RAM)), non-volatile (such as read only memory (ROM), flash memory, etc.) or some combination of the two. The memory 826 stores instructions that, when executed by the processor(s) 814, causes the processor(s) 814 to perform various operations. In various examples, the memory 826 stores methods, threads, processes, applications, objects, modules, any other sort of executable instruction, or a combination thereof. In some cases, the memory 826 stores files, databases, or a combination thereof. In some examples, the memory 826 includes, but is not limited to, RAM, ROM, EEPROM, flash memory, or any other memory technology. In some examples, the memory 826 includes one or more of CD-ROMs, DVDs, CAM, or other optical storage, magnetic cassettes, magnetic tape, magnetic disk storage or other magnetic storage devices, or any other medium which can be used to store the desired information. In various cases, the memory 826 stores instructions, programs, threads, objects, data, or any combination thereof, that cause the processor(s) 814 to perform various functions. In various cases, the memory 826 stores one or more parameters that are detected by the chest compression device 800 and/or reported to the chest compression device 800.

In some cases, the external device(s) 818 include the ventilation device 112 described above. According to various implementations, the memory 826 also stores instructions for executing a coordinator 828, which, when executed by the processor(s) 814, causes the processor(s) 814 to coordinate with the external device(s) 818, such as by administering therapy (e.g., chest compressions) to a subject 806 based on communication between the chest compression device 800 and the external device(s) 818, as described herein. In some implementations, the processor(s) 814, when executing the coordinator 828, receives data (e.g., an instruction(s) from the ventilation device 112, analyzes the data to determine a control parameter(s), and administers, and/or ceases to administer, therapy (e.g., chest compressions) in accordance with the control parameter(s), as described herein.

### Example Clauses

1. A system comprising: an airway sensor configured to detect a partial pressure of carbon dioxide (CO₂) in an airway of a subject; an output device; and a processor configured to: generate a CO₂ waveform indicating the partial pressure of CO₂; identify a chest compression artifact exhibited in the CO₂ waveform indicative of chest compressions that are being administered to the subject; determine, based on the chest compression artifact, a chest compression parameter associated with the chest compressions; and cause coaching information to be output via an output device based on an analysis of the chest compression parameter.
2. The system of clause 1, wherein the airway sensor is further configured to detect a flow rate of air flowing in a fluidic circuit comprising the airway of the subject, wherein the processor is further configured to: generate airflow data indicating the flow rate of the air; identify a second chest compression artifact exhibited in the airflow data; and
determine that chest compressions are being administered to the subject based on the chest compression artifact and the second chest compression artifact.
3. The system of clause 1 or 2, wherein the airway sensor is further configured to detect a pressure associated with the airway of the subject, wherein the processor is further configured to: generate air pressure data indicating the pressure associated with the airway of the subject; identify a second chest compression artifact exhibited in the air pressure data; and determine that chest compressions are being administered to the subject based on the chest compression artifact and the second chest compression artifact.
4. The system of any one of clauses 1 to 3, wherein: the chest compression parameter comprises a number of the chest compressions that have been consecutively administered to the subject; the analysis of the chest compression parameter comprises determining that the number of the chest compressions satisfies a threshold; and the coaching information comprises a timing of administering a ventilation to the subject via a ventilation device connected to the airway of the subject.
5. A system comprising: a sensor configured to detect a carbon dioxide (CO₂) parameter associated with a subject; and a processor configured to: generate CO₂ data indicating the CO₂ parameter; identify a chest compression artifact exhibited in the CO₂ data; determine, based on the chest compression artifact, a chest compression parameter associated with chest compressions that are being administered to the subject; and cause performance of an action based on an analysis of the chest compression parameter.
6. The system of clause 5, wherein the sensor is further configured to detect an airflow parameter associated with air flowing in a fluidic circuit comprising an airway of the subject, wherein the processor is further configured to: generate airflow data indicating the airflow parameter; identify a second chest compression artifact exhibited in the airflow data; and determine that chest compressions are being administered to the subject based on the chest compression artifact and the second chest compression artifact.
7. The system of clause 5 or 6, wherein the sensor is further configured to detect an air pressure parameter associated with an airway of the subject, wherein the processor is further configured to: generate air pressure data indicating the air pressure parameter; identify a second chest compression artifact exhibited in the air pressure data; and determine that chest compressions are being administered to the subject based on the chest compression artifact and the second chest compression artifact.
8. The system of any one of clauses 5 to 7, further comprising an output device, wherein: the chest compression parameter comprises a number of the chest compressions that have been consecutively administered to the subject; the analysis of the chest compression parameter comprises determining that the number of the chest compressions satisfies a threshold; and causing the performance of the action comprises causing coaching information to be output via the output device, the coaching information comprising a timing of administering a ventilation to the subject via a ventilation device.
9. The system of any one of clauses 5 to 8, further comprising an output device, wherein: the processor is further configured to detect, based on the CO₂ data, a return of spontaneous circulation (ROSC) associated with the subject; the analysis of the chest compression parameter comprises determining that the chest compressions are being administered to the subject after the ROSC; causing the performance of the action comprises causing coaching information to be output via the output device, the coaching information comprising a recommendation to cease administering the chest compressions.
10. The system of any one of clauses 5 to 9, further comprising a mechanical chest compression device configured to administer the chest compressions, wherein: the processor is further configured to detect, based on the CO₂ data, a return of spontaneous circulation (ROSC) associated with the subject; the analysis of the chest compression parameter comprises determining that the chest compressions are being administered to the subject after the ROSC; causing the performance of the action comprises causing an instruction to cease administering the chest compressions to be sent to the mechanical chest compression device.
11. The system of any one of clauses 5 to 10, further comprising a mechanical chest compression device configured to administer the chest compressions, wherein the processor is further configured to: determine that a value of the CO₂ parameter detected by the sensor fails to satisfy a threshold, wherein causing the performance of the action comprises causing an instruction to adjust a depth of the chest compressions to be sent to the mechanical chest compression device.
12. The system of any one of clauses 5 to 11, wherein the analysis of the chest compression parameter comprises determining, based on comparing the chest compression parameter with the CO₂ data, a quality of cardiopulmonary resuscitation (CPR) that is being administered to the subject.
13. The system of any one of clauses 5 to 12, wherein: the sensor is an airway sensor; and the airway sensor is a component of, or an accessory to, a ventilation device that is being used to ventilate the subject as part of cardiopulmonary resuscitation (CPR) that is being administered to the subject.
14. A method comprising: detecting, by a sensor, a carbon dioxide (CO₂) parameter associated with a subject; generating, by a processor, CO₂ data indicating the CO₂ parameter; identifying, by the processor, a chest compression artifact exhibited in the CO₂ data; determining, by the processor, and based on the chest compression artifact, a chest compression parameter associated with chest compressions that are being administered to the subject; and causing, by the processor, an action to be performed based on an analysis of the chest compression parameter.
15. The method of clause 14, further comprising: detecting, by the sensor, an airflow parameter associated with air flowing in a fluidic circuit comprising an airway of the subject; generating, by the processor, airflow data indicating the airflow parameter; identifying, by the processor, a second chest compression artifact exhibited in the airflow data; and determining, by the processor, that the chest compressions are being administered to the subject based on the chest compression artifact and the second chest compression artifact.
16. The method of clause 14 or 15, further comprising: detecting, by the sensor, an air pressure parameter associated with an airway of the subject; generating, by the processor, air pressure data indicating the air pressure parameter; identifying, by the processor, a second chest compression artifact exhibited in the air pressure data; and determining, by the processor, that the chest compressions are being administered to the subject based on the chest compression artifact and the second chest compression artifact.
17. The method of any one of clauses 14 to 16, wherein: the chest compression parameter comprises a number of the chest compressions that have been consecutively administered to the subject; the analysis of the chest compression parameter comprises determining, by the processor, that the number of the chest compressions satisfies a threshold; and the causing the action to be performed comprises causing coaching information to be output via an output device, the coaching information comprising a timing of administering a ventilation to the subject via a ventilation device.
18. The method of any one of clauses 14 to 17, further comprising detecting, by the processor, and based on the CO₂ data, a return of spontaneous circulation (ROSC) associated with the subject, wherein: the analysis of the chest compression parameter comprises determining, by the processor, that the chest compressions are being administered to the subject after the ROSC; and the causing the action to be performed comprises causing coaching information to be output via an output device, the coaching information comprising a recommendation to cease administering the chest compressions.
19. The method of any one of clauses 14 to 18, further comprising detecting, by the processor, and based on the CO₂ data, a return of spontaneous circulation (ROSC) associated with the subject, wherein: the analysis of the chest compression parameter comprises determining, by the processor, that the chest compressions are being administered to the subject after the ROSC; and the causing the action to be performed comprises causing an instruction to cease administering the chest compressions to be sent to a mechanical chest compression device that is administering the chest compressions.
20. The method of any one of clauses 14 to 19, wherein: the chest compression parameter comprises a number of the chest compressions that have been consecutively administered to the subject; the analysis of the chest compression parameter comprises: determining, by the processor, that the number of the chest compressions satisfies a first threshold; and in response to the determining that the number of the chest compressions satisfies the first threshold, determining, by the processor, that a value of the CO₂ parameter detected by the sensor fails to satisfy a second threshold; and the causing the action to be performed comprises causing coaching information to be output via an output device, the coaching information based on the determining that the value fails to satisfy the second threshold.
21. A system comprising: an airway sensor configured to detect: a partial pressure of carbon dioxide (CO₂) in an airway of a subject; and an airway parameter associated with the airway of the subject, wherein the airway parameter is different than the partial pressure of CO₂; an output device; and a processor configured to: generate a CO₂ waveform indicating the partial pressure of CO₂; generate airway data indicating the airway parameter; identify a chest compression artifact exhibited in at least one of the CO₂ waveform or the airway data; determine, based on the chest compression artifact, that chest compressions are being administered to the subject; determine a discordance between the CO₂ waveform and the airway data; and cause information to be output via an output device based on determining the discordance, the information indicative of a potential issue relating to care being provided to the subject.
22. The system of clause 21, wherein the processor is further configured to: determine that a first value of the airway parameter satisfies a first threshold; and determine that a second value of the partial pressure of CO₂ fails to satisfy a second threshold; wherein causing the information to be output is further based on determining that the first value satisfies the first threshold and determining that the second value fails to satisfy the second threshold.
23. The system of clause 21 or 22, wherein the information comprises a recommendation to check for an air leak associated with a ventilation device connected to the airway of the subject.
24. The system of any one of clauses 21 to 23, wherein the information comprises a recommendation relating to cardiopulmonary resuscitation (CPR) that is being administered to the subject.
25. The system of clause 24, wherein the recommendation is to adjust a depth of the chest compressions or a frequency of the chest compressions.
26. A system comprising: a sensor configured to detect: a carbon dioxide (CO₂) parameter associated with a subject; and an airway parameter associated an airway of the subject, wherein the airway parameter is different than the CO₂ parameter; an output device; and a processor configured to: generate CO₂ data indicating the CO₂ parameter; generate airway data indicating the airway parameter; identify a chest compression artifact exhibited in at least one of the CO₂ data or the airway data; determine, based on the chest compression artifact, that chest compressions are being administered to the subject; determine a discordance between the CO₂ data and the airway data; and cause information to be output via the output device based on determining the discordance, the information indicative of a potential issue relating to care being provided to the subject.
27. The system of clause 26, wherein the processor is further configured to: determine that a first value of the airway parameter satisfies a first threshold; and determine that a second value of the CO₂ parameter fails to satisfy a second threshold, wherein causing the information to be output is further based on determining that the first value satisfies the first threshold and determining that the second value fails to satisfy the second threshold.
28. The system of clause 26 or 27, wherein the information comprises a recommendation to check for an air leak associated with a ventilation device connected to the airway of the subject.
29. The system of any one of clauses 26 to 28, wherein the information comprises a recommendation relating to cardiopulmonary resuscitation (CPR) that is being administered to the subject.
30. The system of clause 29, wherein the recommendation is to adjust a depth of the chest compressions or a frequency of the chest compressions.
31. The system of any one of clauses 26 to 30, further comprising a mechanical chest compression device configured to administer the chest compressions, wherein the processor is further configured to cause an instruction to adjust a depth of the chest compressions or a frequency of the chest compressions to be sent to the mechanical chest compression device.
32. The system of any one of clauses 26 to 31, wherein: the sensor is an airway sensor; and the airway sensor is a component of, or an accessory to, a ventilation device that is being used to ventilate the subject as part of cardiopulmonary resuscitation (CPR) that is being administered to the subject.
33. A method comprising: detecting, by a sensor: a carbon dioxide (CO₂) parameter associated with a subject; and an airway parameter associated an airway of the subject, wherein the airway parameter is different than the CO₂ parameter; generating, by a processor, CO₂ data indicating the CO₂ parameter; generating, by a processor, airway data indicating the airway parameter; identifying, by the processor, a chest compression artifact exhibited in at least one of the CO₂ data or the airway data; determining, by the processor, and based on the chest compression artifact, that chest compressions are being administered to the subject; determining, by the processor, a discordance between the CO₂ data and the airway data; and causing, by the processor, information to be output via an output device based on determining the discordance, the information indicative of a potential issue relating to care being provided to the subject.
34. The method of clause 33, further comprising: determining, by the processor, that a first value of the airway parameter satisfies a first threshold; and determining, by the processor, that a second value of the CO₂ parameter fails to satisfy a second threshold;
wherein the causing the information to be output is further based on the determining that the first value satisfies the first threshold and the determining that the second value fails to satisfy the second threshold.
35. The method of clause 33 or 34, wherein the information comprises a recommendation to check for an air leak associated with a ventilation device connected to the airway of the subject.
36. The method of any one of clauses 33 to 35, wherein the information comprises a recommendation relating to cardiopulmonary resuscitation (CPR) that is being administered to the subject.
37. The method of any one of clauses 33 to 36, wherein the discordance comprises a time interval between a first peak in the CO₂ data and a second peak in the airway data.
38. The method of any one of clauses 33 to 37, further comprising causing, by the processor, an instruction to adjust a depth of the chest compressions or a frequency of the chest compressions to be sent to a mechanical chest compression device that is administering the chest compressions.
39. The method of any one of clauses 33 to 38, wherein: the sensor is an airway sensor; and the airway sensor is a component of, or an accessory to, a ventilation device that is being used to ventilate the subject as part of cardiopulmonary resuscitation (CPR) that is being administered to the subject.
40. The method of any one of clauses 33 to 39, further comprising: determining, by the processor, and based on the chest compression artifact, a number of the chest compressions that have been consecutively administered to the subject; determining, by the processor, that the number of the chest compressions satisfies a first threshold; and in response to the determining that the number of the chest compressions satisfies the first threshold, determining, by the processor, that a value of the CO₂ parameter detected by the sensor fails to satisfy a second threshold, wherein the causing the information to be output is based on the determining that the value fails to satisfy the second threshold.

While the example clauses described above are described with respect to one particular implementation, it should be understood that, in the context of this document, the content of the example clauses can also be implemented via a method, device, system, computer-readable medium, and/or another implementation. Additionally, any one of examples 1-40 may be implemented alone or in combination with any other of the examples 1-40.

### Conclusion

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; +10% of the stated value; ±9% of the stated value; ±8% of the stated value; +7% of the stated value; ±6% of the stated value; +5% of the stated value; +4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

1. A system comprising:
a sensor configured to detect a carbon dioxide (CO₂) parameter associated with a subject; and
a processor configured to:
generate CO₂ data indicating the CO₂ parameter;
identify a chest compression artifact exhibited in the CO₂ data;
determine, based on the chest compression artifact, a chest compression parameter associated with chest compressions that are being administered to the subject; and
cause performance of an action based on an analysis of the chest compression parameter.

2. The system of claim 1, wherein the sensor is further configured to detect an airway parameter associated with an airway of the subject, wherein the processor is further configured to:
generate airway data indicating the airway parameter;
identify a second chest compression artifact exhibited in the airway data; and
determine that the chest compressions are being administered to the subject based on the chest compression artifact and the second chest compression artifact.

3. The system of claim 2, wherein the airway parameter comprises an airflow parameter associated with air flowing in a fluidic circuit comprising the airway, and wherein the airway data comprises airflow data indicating the airflow parameter.

4. The system of claim 2, wherein the airway parameter comprises a partial pressure of oxygen, a level of the oxygen in air present in the airway or flowing in a fluidic circuit comprising the airway, a partial pressure of argon, a level of the argon in the air, a partial pressure of nitrogen, a level of the nitrogen in the air, a temperature of the air, a humidity of the air, ventilation rate, inspiratory time, or expiratory time.

5. The system of claim 1, wherein the sensor is further configured to detect an air pressure parameter associated with an airway of the subject, wherein the processor is further configured to:
generate air pressure data indicating the air pressure parameter;
identify a second chest compression artifact exhibited in the air pressure data; and
determine that the chest compressions are being administered to the subject based on the chest compression artifact and the second chest compression artifact.

6. The system of claim 1, wherein:
the chest compression parameter comprises a number of the chest compressions that have been consecutively administered to the subject;
the analysis of the chest compression parameter comprises determining that the number of the chest compressions satisfies a threshold; and
causing the performance of the action comprises causing coaching information to be output via an output device, the coaching information comprising a timing of administering a ventilation to the subject via a ventilation device.

7. The system of any one of claim 1, wherein:
the processor is further configured to detect, based on the CO₂ data, a return of spontaneous circulation (ROSC) associated with the subject; and
the analysis of the chest compression parameter comprises determining that the chest compressions are being administered to the subject after the ROSC.

8. The system of claim 7, wherein:
causing the performance of the action comprises causing coaching information to be output via an output device, the coaching information comprising a recommendation to cease administering the chest compressions; and/or causing the performance of the action comprises causing an instruction to cease administering the chest compressions to be sent to a mechanical chest compression device.

9. The system of claim 1, wherein the processor is further configured to:
determine that a value of the CO₂ parameter detected by the sensor fails to satisfy a threshold,
wherein causing the performance of the action comprises causing an instruction to adjust a depth of the chest compressions to be sent to a mechanical chest compression device.

10. The system of claim 1, wherein the analysis of the chest compression parameter comprises determining, based on comparing the chest compression parameter with the CO₂ data, a quality of cardiopulmonary resuscitation (CPR) that is being administered to the subject.

11. The system of claim 1, wherein:
the sensor is an airway sensor; and
the airway sensor is a component of, or an accessory to, a ventilation device that is being used to ventilate the subject as part of cardiopulmonary resuscitation (CPR) that is being administered to the subject.

12. A method comprising:
receiving, by a processor, a carbon dioxide (CO₂) parameter associated with a subject;
generating, by the processor, CO₂ data indicating the CO₂ parameter;
identifying, by the processor, a chest compression artifact exhibited in the CO₂ data;
determining, by the processor, and based on the chest compression artifact, a chest compression parameter associated with chest compressions that are being administered to the subject; and
causing, by the processor, an action to be performed based on an analysis of the chest compression parameter.

13. The method of claim 12, further comprising:
receiving, by the processor, an airway parameter associated with an airway of the subject;
generating, by the processor, airway data indicating the airway parameter;
identifying, by the processor, a second chest compression artifact exhibited in the airway data; and
determining, by the processor, that the chest compressions are being administered to the subject based on the chest compression artifact and the second chest compression artifact.

14. The method of claim 13, wherein the airway parameter comprises an airflow parameter associated with air flowing in a fluidic circuit comprising the airway, and wherein the airway data comprises airflow data indicating the airflow parameter.

15. The method of claim 13, wherein the airway parameter comprises a partial pressure of oxygen, a level of the oxygen in air present in the airway or flowing in a fluidic circuit comprising the airway, a partial pressure of argon, a level of the argon in the air, a partial pressure of nitrogen, a level of the nitrogen in the air, a temperature of the air, a humidity of the air, ventilation rate, inspiratory time, or expiratory time.

16. The method of claim 12, further comprising:
receiving, by the processor, an air pressure parameter associated with an airway of the subject;
generating, by the processor, air pressure data indicating the air pressure parameter;
identifying, by the processor, a second chest compression artifact exhibited in the air pressure data; and
determining, by the processor, that the chest compressions are being administered to the subject based on the chest compression artifact and the second chest compression artifact.

17. The method of claim 12, wherein:
the chest compression parameter comprises a number of the chest compressions that have been consecutively administered to the subject;
the analysis of the chest compression parameter comprises determining, by the processor, that the number of the chest compressions satisfies a threshold; and
the causing the action to be performed comprises causing coaching information to be output via an output device, the coaching information comprising a timing of administering a ventilation to the subject via a ventilation device.

18. The method of claim 12, further comprising detecting, by the processor, and based on the CO₂ data, a return of spontaneous circulation (ROSC) associated with the subject.

19. The method of claim 18, wherein:
the analysis of the chest compression parameter comprises determining, by the processor, that the chest compressions are being administered to the subject after the ROSC; and
the causing the action to be performed comprises causing coaching information to be output via an output device, the coaching information comprising a recommendation to cease administering the chest compressions, and/or causing an instruction to cease administering the chest compressions to be sent to a mechanical chest compression device that is administering the chest compressions.

20. The method of claim of 12, wherein:
the chest compression parameter comprises a number of the chest compressions that have been consecutively administered to the subject;
the analysis of the chest compression parameter comprises:
determining, by the processor, that the number of the chest compressions satisfies a first threshold; and
in response to the determining that the number of the chest compressions satisfies the first threshold, determining, by the processor, that a value of the CO₂ parameter received by the processor fails to satisfy a second threshold; and
the causing the action to be performed comprises causing coaching information to be output via an output device, the coaching information based on the determining that the value fails to satisfy the second threshold.

21-46. (canceled)
